(19) United States
(12) Patent Application Publication
(10) Pub. No.: US 2025/0280860 A1
(43) Pub. Date: Sep. 11, 2025

(54) METHOD FOR EXTRACTING A LIPID-, A PROTEIN-, AND/OR A CARBOHYDRATE-CONTAINING COMPOSITION FROM OIL-RICH SEEDS

(71) Applicant: CANO-ELA B.V., Ede (NL)

(72) Inventors: Maria Juliana ROMERO GUZMÁN, Ede (NL); Alberto NICCOLAI, Ede (NL)

(21) Appl. No.: 18/706,291

(22) PCT Filed: Nov. 2, 2022
(86) PCT No.: PCT/EP2022/080584

§ 371 Date: Apr. 30, 2024

(30) Foreign Application Priority Data
Nov. 2, 2021 (NL) 2029591

(51) Int. Cl. A23L 25/00; A23J 1/14; B01D 11/02

(52) U.S. Cl. CPC A23L 25/30; A23J 1/14; B01D 11/0288

(57) ABSTRACT

The present invention relates to a method for obtaining a lipid-containing composition, a protein-containing composition and/or a carbohydrate-containing composition, for example from plant seeds. The present invention relates to a significantly improved aqueous extraction process for application at an industrial scale. The present invention also relates to the products provided by the method.

### CROSS-REFERENCE TO RELATED APPLICATIONS

This application is a national-phase application, under 35 U.S.C. 371, of International Application No. PCT/EP2022/080584, filed Nov. 2, 2022, which in turn claims the priority benefit of Netherlands Application No. 2029591, filed Nov. 2, 2021. Each of these applications is incorporated herein by reference in its entirety for all purposes.

### TECHNICAL FIELD

The present invention relates to a method for obtaining a lipid-containing composition, a protein-containing composition and/or a carbohydrate-containing composition, preferably from plant oil-rich seeds, and products obtained by the method.

### BACKGROUND OF THE INVENTION

Agriculture accounts for around 30% of the global energy consumption and 92% of the human water footprint, therefore it is important to develop food production systems that make most efficient use of resources while implementing greener processes.

Industrialized production of processed food can be roughly divided into the steps of 1) production of ingredients and 2) assembly of these ingredients into final products. In the first step, the raw materials are refined into basic building blocks such as oil, protein, carbohydrates, and fibres.

Plant seeds and grains are popular raw materials for innovative food production systems as they comprise various of aforementioned ingredients, such as a particularly high oil and protein content, and high nutritional value.

The conventional method of separating oil, protein and carbohydrate from agricultural crops generally uses solvents such as hexane. However, the solvent extraction methods often are time-consuming and need extensive refinements to yield the final ingredients, therefore having high environmental impact. In addition, harsh solvents may negatively influence, besides macronutrients and carbohydrates, the quality of the oil and protein ingredients.

Aqueous extraction processes are typically considered to be a greener alternative to the conventional methods, which may also have less detrimental effects on the ingredients in the raw materials.

Aqueous extraction processes have been designed primarily to isolate proteins, however as oils are stored in intracellular organelles named oleosomes, their recovery in aqueous media is also possible. The hydrophilic nature of the oleosome interface given by the presence of phospholipids and proteins allows their extraction by aqueous solvents and yield a stable oil-in-water emulsions. A wide range of food products such as yogurt, cheese, spreads, mayonnaise, chocolate and ice-cream are examples of emulsions. The creation of either as oil-in-water or as water-in-oil emulsions can be done by incorporation of stabilizing emulsifiers (additives) with amphiphilic properties. There is however an increasing skepticism against these additives amongst consumers and an increasing demand on cleaner food labels that report more natural less artificial-sounding ingredients. Using aqueous extraction, to fractionate the seeds makes redundant to recreate an emulsion from the extracted oil, since the natural structures that contain this oil in situ (the oleosomes) strongly resemble manufactured emulsions.

A typical aqueous extraction process, when taking extraction from plant seeds as example, comprises:
a) immersing the seeds in an aqueous solution (e.g. soaking) to soften its components;
b) comminution of the seeds to lyse the cells and release the components;
c) solid-liquid separation, which encompasses the separation of non-soluble and soluble components, yielding an opaque dispersion which contains oleosomes, proteins, some soluble carbohydrates and very fine pieces of insoluble ones;
c) a series of liquid-liquid separation steps to recover the concentrated cream which is rich in oleosomes and proteins.

Even though the aforementioned aqueous extraction process has clear advantages, it also has some drawbacks:
The current process is extremely time-consuming and requires multiple centrifugation and washing cycles, which hampers upscaling and industrialized production. For example, it may take up to at least 32 hours from raw material to end product (De Chirico et al. Food Chem. 2018 Feb. 15; 241:419-426, Romero-Guzmán et al. Food and Bioproducts Processing. Volume 121, May 2020).
The purity, composition and/or functionality of the recovered fractions are currently suboptimal. The protocols are normally designed in favour of harnessing as much as possible of one major component and do not take into account adverse effects on the other valuable biomass components. For example, the oleosome extraction is generally performed entirely at alkaline conditions, which is required to increase the solubility of the oleosomes intrinsic proteins, which at this conditions makes them negatively charged (De Chirico et al. Food Chem. 2018 Feb. 15; 241:419-426, Romero-Guzmán et al. LWT—Food Science and Technology 123 (2020) 109120). However, this may reduce the functionality of the co-extracted material (i.e. storage proteins) and result in an unwanted bond-formation and reconfiguration or denaturation of the proteins.
At the required alkaline conditions, the first liquid extract obtained after comminution and filtration of the seeds, does not have the appropriate rheological/colloidal characteristics that would allow the liquid-liquid centrifugation step to be performed in a continuous manner, such as by disk centrifugation. This also hampers upscaling and industrialized production.

Overall, all these problems limit the feasibility of the current process and hence its application at the industrial scale. It is an objective of the present invention to overcome one or more of the above-mentioned problems and/or to design a sustainable and feasible aqueous extraction method that yields lipid-, protein- and carbohydrate-containing compositions. The compositions are for instance suitable for use in consumer foods, supplements, nutraceutical, pharmaceutical, or in cosmetic products.

### SUMMARY OF THE INVENTION

The current inventors identified an effective and up-scalable method for the isolation of lipid, protein- and carbohydrate-containing compositions from plant seeds.

Unexpectedly, the present inventors found that a switch from alkali pH to a (closer to) neutral pH and/or a weak acidic pH (e.g. preferably pH 4.0-7.5, more preferably pH 5.0-6.5), in order to aggregate lipids and/or proteins at the right moment, i.e. specifically prior to liquid-liquid separation but after liquid-solid separation, leads to an improved recovery of a concentrated cream which is rich in oleosomes and proteins in a native state. Moreover, the pH adjustment allows liquid-liquid separation at a lower centrifugation force (e.g. preferably at a force below 10,000×g, such as 1500×g-5000×g using batch-wise density gradient centrifugation or 5000×g-10,000×g using continuous density gradient centrifugation), whereas conventionally g forces used to recover the creamy part are set at around 10,000×g or more, which is preferred/utilized to increase the amount of cream recovered and its purity (cream just composed by oleosomes) (De Chirico et al. Food Chem. 2018 Feb. 15; 241:419-426, Romero-Guzmán et al. Food and Bioproducts Processing. Volume 121, May 2020). The finding was unexpected, since the prior art (e.g. Romero-Guzmán et al. LWT—Food Science and Technology 123 (2020) 109120, Romero-Guzmán et al. Food and Bioproducts Processing. Volume 121, May 2020) indicates that it is advantageous to use entirely alkaline conditions for better extraction of proteins and lipids as compared to the use of neutral pH.

This follows the observation that at alkali pH, the oleosome-associated proteins are negatively charged, which increases their solubility and release. This aspect of the invention, i.e. a switch from alkali pH to a (closer to) neutral pH and/or a weak acidic pH (e.g. preferably pH 4.0-7.5, more preferably pH 5.0-6.5) at the right moment, which provides a better functionality of the co-extracted fractions and avoids the multiple, lengthy centrifugation and washing steps normally needed, resulting in a lower energy consumption.

In addition, the present inventors found that an additional blanching step of plant seeds at the start of the aqueous extraction process ultimately leads to a more stable and improved shelf-life of the obtained fractions. It is generally assumed that a heating step should be avoided as it is believed to denature proteins, however the denaturation of proteins in such a way could hinder their recovery, however such an effect was not observed by the current inventors for the specific blanching method that was identified. The current inventors found that the specific combination of time (preferably between 0.5 and 2 minutes, e.g. 1 minute) and temperature (preferably between 60-80° C., e.g. 70° C.) results in an unexpected improvement in stability and shelf-life of the fractions as compared to longer blanching times at lower temperatures. Moreover, the specific time chosen resulted in an improvement in the enriched fractions with more stable biochemical composition profiles as compared to other blanching temperatures. This aspect of the invention, i.e. providing an additional blanching step, significantly accelerates the process and improves the yield of ingredients.

Moreover, the present inventors surprisingly found that immersing the plant seeds in an aqueous medium (preferably a salt solution, e.g. an NaHCO₃ solution) having a temperature of preferably 50-70° C. (e.g. 60° C.) but only for reduced period of time (preferably between 30 and 150 minutes, e.g. 60 minutes), leads to optimal yield of lipid-, protein- and/or carbohydrate-containing fractions by loosening up the components in the seeds. This may be an important improvement over the lengthy soaking steps disclosed in the literature. The effects of this step were unexpected, since the literature (e.g. De Chirico et al. Food Chem. 2018 Feb. 15; 241:419-426, Romero-Guzmán et al. Food and Bioproducts Processing. Volume 121, May 2020) stresses the need of a soaking time of at least 8 h, and generally between 16 to 24 hours, which delays the process and increases the chance of microbial growth, among the many other possible limitations. Moreover, as it was mentioned already in the blanching step section, it is generally assumed that a heating step should be avoided as it is believed to denature proteins. This aspect of the invention, i.e. immersing the plant seeds in an aqueous medium having increased temperature, significantly accelerates the process, for example at least 15 hours as compared to de Chirico et al. (Food Chem. 2018 Feb. 15; 241:419-426) and at least 7 hours as compared to Romero-Guzmán et al. (Food and Bioproducts Processing. Volume 121, May 2020). This condition may render the process scalable at an industrial level, allow lower energy consumption (reduction of g forces), and facilitate the separation of lipids and/or oleosomes.

Finally, the present inventors surprisingly found that the present method allows for the isolation of a lipid-containing composition and a protein-containing composition by means of continuous centrifugation, such as disk centrifugation, whereas this is not possible when using the aqueous extraction processes disclosed in the prior art. Specifically, at the required alkaline conditions in the prior art, the liquid does not have the appropriate rheological/colloidal characteristics that would allow the liquid-liquid centrifugation step to be performed in a continuous manner. This aspect of the invention, i.e. the use of continuous centrifugation, allows for improved upscaling and industrialized production.

Overall, the present inventors have found a sustainable and feasible aqueous extraction method that yields lipid-, protein- and carbohydrate-containing compositions that are for instance suitable to use in consumer foods.

### DETAILED DESCRIPTION OF THE INVENTION

The present invention relates to a method for obtaining a lipid-containing composition, a protein-containing composition and/or a carbohydrate-containing composition, the method comprising:
a) providing plant seeds;
b) immersing the plant seeds provided in step a) in an aqueous medium to obtain plant seeds comprising aqueous medium;
c) comminuting the plant seeds comprising aqueous medium obtained in step b) to obtain a liquid fraction and a solid fraction, preferably wherein the liquid fraction comprises lipid and protein in a lipid:protein ratio of between 10:1 (w/w) and 1:10 (w/w) and/or preferably wherein the solid fraction is the carbohydrate-containing composition which may comprise at least 10 wt. % carbohydrate;
d) preferably, adjusting the pH of the liquid fraction obtained in step c) to a pH of between 4.0-7.5, preferably of between 4.0-6.5 or 5.0-6.5, e.g. to aggregate lipids and/or proteins in the liquid fraction; and
e) separating the (aggregated) lipids and/or the (aggregated) proteins obtained in step d) to obtain the lipid-containing composition and/or the protein-containing composition.

In a preferred embodiment, steps a) to e) in the method as taught herein together are performed in a total time of in between 1 minute and 8 hours, preferably of in between 1 minute and 6 hours, more preferably of in between 1 minute and 4 hours, and/or are performed in a continuous process. In addition or alternatively, the steps a)-α), preferably at least c), d), e) are performed in the recited order. Preferably, there are no intermediate processing steps between steps c) and d) and/or preferably there are no intermediate steps between steps d) and e).

In addition or alternatively, in yet another preferred embodiment, steps a) to e) in the method as taught herein together are performed in a total time of in between 1 minute and 8 hours, preferably of in between 1 minute and 6 hours, more preferably of in between 1 minute and 4 hours, most preferably of in between 1 minute and 2 hours, and/or is performed in a continuous process, wherein the total time is:
per kg, per 10 kg, per 100 kg, per 1000 kg, per 10000, per 100000, or per 1000000 kg of plant seeds provided in step a) in the method as taught herein; and/or
per L, per 10 L, per 100 L, per 1000 L, per 10000 L, per 100000 L, or per 1000000 L, wherein the volume is the capacity of an apparatus used to perform steps b), c) and/or e) in the method as taught herein.

The method as taught herein, and the products obtained thereby, are for example suitable for food, feed, cosmetic, supplement, pharmaceutical, and/or other industrial applications.

The method as taught herein and/or the individual steps therein is preferably performed as a continuous process. The term ‘continuous process’ relates to a process that typically allows for a continuous and/or constant supply of starting material, for example for at least 1, 2, 3, 4, 5, 10, 20, 30, 60 hours, e.g. in conjunction with a continuous and/or constant collection of processed material. This generally contrasts non-continuous or batch-wise processes, wherein the process is delayed or stopped to provide a new batch of starting material and/or collect a produced batch of end material. Screw pressing, separation with a cream separator, and disk centrifugation can be considered as continuous processes. In the current disclosure, a continuous process may for example lead to constant new supply and processing of plant, without the process being repeatedly interrupted. In addition or alternatively, in the current disclosure, a continuous process may lead to constant collection of processed material and/or the process is not (repeatedly) interrupted, for example the process proceeds uninterrupted for at least 1, 2, 3, 4, 5, 6, 7, 8, 9, 10, 12, 14, 16, 18, 20, 22, 24, 30, 40, 50, 75, 100 hours. Advantages of continuous processing may be that it may be more automated, more efficient, and/or larger volumes of material may be processed. Continuous processes are generally considered to be industrially scalable and therefore advantageous over non-continuous or batch-wise processes.

In a preferred embodiment, the plant seeds as taught herein are oil-rich plant seeds, wherein the oil-rich plant seeds are one or more of sunflower seeds, rapeseeds, pumpkin seeds, cotton seeds, maize seeds, canola seeds, safflower seeds, sesame seeds, or combinations thereof, preferably rapeseeds, canola seeds and/or sunflower seeds. Preferably, the rapeseeds, canola seeds and/or or sunflower seeds as disclosed herein have no erucic acid content or less than 1 wt. % erucic acid, and/or a low level of glucosinolates, e.g. less than 1 wt. %.

In an embodiment, the plant seeds as taught herein are a mixture of two or more types of plant seeds, preferably a mixture of two or more types of oil-rich plant seeds as taught herein.

The term ‘oil-rich plant seed’ as used herein relates to a plant seed that can yield oil (preferably edible oil), without reference to the amount or type of oil.

The aqueous medium as taught herein, e.g. as used in step b) of the method as taught herein, may be water such as ultra-pure water or tap water. In addition or alternatively, the aqueous medium may comprise cations, preferably monovalent or divalent cations. In an embodiment, the aqueous medium as taught herein comprises Na+, preferably 0.01-0.5 mol/L Na+, more preferably 0.05-0.15 mol/L Na+ and/or has pH 8-11, preferably pH 9-10 (e.g. pH 9.5). In an embodiment, the aqueous medium as taught herein comprises K+, preferably 0.05-0.5 mol/L K+, more preferably 0.15-0.25 mol/L K+ and/or has pH 5-9, preferably pH 6-8, most preferably pH 6.5-7.5 (e.g. pH 7.0). In an embodiment, the aqueous medium as taught herein comprises Mg²⁺, preferably 0.01-0.5 mol/L Mg²⁺, more preferably 0.05-0.15 mol/L mol/L Mg²⁺, and/or has pH 5-9, preferably pH 6-8, most preferably pH 6.5-7.5 (e.g. pH 7.0). In an embodiment, the aqueous medium as taught herein comprises Ca²⁺, preferably 0.01-0.5 mol/L Ca²⁺, more preferably 0.05-0.15 mol/L Mg²⁺, and/or has pH 5-9, preferably pH 6-8, most preferably pH 6.5-7.5 (e.g. pH 7.0).

A pH of 8-11, preferably 9-10 for the aqueous medium in step b) is useful, particularly during the initial and actual extraction of oleosomes from the cells. Additionally this pH range is useful to charge the oleosomes to the point that they are repelling “impurities” from their surroundings. However, it was found that it is difficult to recover the oleosomes at this pH and very high g forces are required, because the oleosomes are charged and they do not want to come together. Accordingly, the present disclosure provides to a switch of pH in step d) to allow to recover oleosomes with low amounts of exogenous material and using lower g forces.

The aqueous medium as taught herein, e.g. as used in step b) of the method as taught herein, may be a salt solution, wherein:
the salt may be NaCl, KCl, MgCl₂, CaCl₂, NaHSO₄, K₂Cr₂O₇, NaHCO₃ (sodium bicarbonate), or combinations thereof;
the salt may have a concentration of 0.01-1 mol/L, more preferably at 0.05-0.5 mol/L; and/or
the pH may be between 6-13, preferably between 8-11, most preferably between 8.5-9.5.

For example, the salt solution as taught herein may comprise any one or more of the substances NaCl, KCl, MgCl₂, CaCl₂, and NaHCO₃ (sodium bicarbonate), wherein the concentration of each substance is 0.01-1 mol/L, more preferably at 0.05-0.5 mol/L. For example, the salt solution as taught herein may comprise any one or more of the substances NaCl, KCl, MgCl₂, CaCl₂, and NaHCO₃ (sodium bicarbonate), wherein the pH of the salt solution is between 6-13, preferably between 8-11, most preferably between 8.5-9.5. For example, the salt solution as taught herein may comprise any one or more of the substances NaCl, KCl, MgCl₂, CaCl₂, and NaHCO₃ (sodium bicarbonate), wherein the concentration of each substance is 0.01-1 mol/L, more preferably at 0.05-0.5 mol/L, and wherein the pH is between 6-13, preferably between 8-11, most preferably between 8.5-9.5 (e.g. pH 9.0).

The aqueous medium and/or salt solution as taught herein may additionally or alternatively be or comprise a phosphate buffer, e.g. comprising one or more of monobasic dihydrogen phosphate and dibasic monohydrogen phosphate.

The aqueous medium and/or salt solution as taught herein may additionally or alternatively be or comprise a phosphate buffered-saline, e.g. comprising disodium hydrogen phosphate, sodium chloride, potassium chloride and potassium dihydrogen phosphate.

The salt solution as taught herein preferably is an NaHCO₃ solution, wherein the NaHCO₃ solution comprises preferably 0.01-1 mol/L NaHCO₃, more preferably 0.05-0.5 mol/L NaHCO₃ (e.g. 0.1 M) and/or wherein the NaHCO₃ has a pH of between 6-13, preferably between 8-11, most preferably between 8.5-9.5 (e.g. pH 9.0).

In a preferred embodiment, the aqueous medium in step b) as taught herein has a temperature of between 20-100° C., preferably 40-80° C., more preferably 50-70° C. (e.g. 60° C.) and/or the immersing in step b) is performed for a time period of between 5 minutes to 8 hours, preferably of between 10 minutes to 4 hours, more preferably of between 30 and 150 minutes (e.g. 120 minutes). In addition or alternatively, the aqueous medium in step b) as taught herein is preferably an NaHCO₃ solution, preferably with a molarity of 0.05-0.5 mol/L (e.g. 0.1 M) and with a pH of between 8 and 11, preferably 8.5 and 9.5 (e.g. pH 9.0).

In various embodiments, step b) as taught herein is performed to soak, solubilize, hydrate and/or loosen the plant seeds and/or the components in the plant seeds.

In an embodiment, step b) as taught herein may be performed to increase the water content of the plant seeds. For example, step b) may be performed to provide a water content of at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 80 wt. %, 90 wt. %, 99 wt. %, or 100 wt. % all relative to the total weight of the plant seeds. In addition or alternatively, step b) as taught herein may be performed for a period of time chosen such that it increases the water content of the plant seeds to provide a water content of at least 5 wt. %, 10 wt. %, 15 wt. %, 20 wt. %, 25 wt. %, 30 wt. %, 35 wt. %, 40 wt. %, 45 wt. %, 50 wt. %, 55 wt. %, 60 wt. %, 65 wt. %, 70 wt. %, 80 wt. %, 90 wt. %, 99 wt. %, or 100 wt. % all relative to the total weight of the plant seeds.

The term ‘water content’ relates to the amount of water in a product relative to the total weight of the product. In the current disclosure, the water content relates to the water content reported on a wet basis, that is, the weight of the water divided by the total weight of the product (solid weight plus water). In the current disclosure, the weight of the water in the material is calculated by subtracting the weight of the solid weight of the material from the total weight of the material. The ‘solid weight’ of the material is defined as the weight obtained after heating a sample (e.g. of 50 g) at between 35° C. to 80° C., more preferably of between 50° C. and 70° C. (e.g. 60° C.) until constant weight, wherein the heating may be performed under vacuum in a laboratory vacuum for 5 hours at 100° C. at 50 mm Hg pressure.

In addition or alternatively, step b) as taught herein may also be performed to reduce the mechanical strength of the plant seeds, wherein step b) is preferably performed to impart a peak force measured on the plant seeds of less than 12 N, such as less than 8 N, preferably less than 6 N, more preferably less than 4 N, most preferably less than 3 N, as measured on the plant seeds using a seed compression test.

In the current disclosure, the mechanical strength relates to the maximum force that can be exerted on the plant seed without breaking it, as for example measured in a seed compression test. In the current disclosure, the seed compression test is preferably performed with the TA.XT plus C Texture Analyzer, operating with the Exponent Connect software, using a 4 mm DIA cylinder stainless probe. After having been weighed, each seed is placed under the probe, to obtain the force (N) necessary to break the seed.

In an embodiment, step b) as taught herein, comprises immersing the plant seeds in an aqueous medium as taught herein in a seed:aqueous medium ratio of 10:1 (w/w) to 1:10 (w/w), more preferably 5:1 (w/w) to 1:5 (w/w), most preferably 2:1 (w/w) to 1:2 (w/w), all based on the weight of the seeds in step a) of the method as taught herein.

In an embodiment, step b) as taught herein is performed for less than 8 hours, preferably less than 6 hours, more preferably less than 4 hours, most preferably less than 2 hours.

Step b) may have one or more of the following effects in the method as taught herein:
increasing the extraction yield of the lipid-containing composition, the protein-containing composition and/or therefore their separation from the carbohydrate-containing composition, and/or increasing the extraction yield of lipid, protein, and/or carbohydrate in total and/or in the respective compositions;
increasing the stability, increasing the shelf-life, reducing the number of micro-organisms, reducing the growth of micro-organisms and/or reducing the enzymatic activity, e.g. in the solid fraction, the liquid fraction, the lipid-containing composition, the protein-containing composition and/or the carbohydrate-containing composition;
facilitate the release of functional components, such as phenolics and/or consequently benefit of their antioxidant activity, e.g. in the solid fraction, in the liquid fraction, in the lipid-containing composition, in the protein-containing composition and/or in the carbohydrate-containing composition;
improving/increasing the cream properties, improving the cream rheological/colloidal properties, increasing the cream aggregation, avoiding and/or reducing the oleosome damage, reducing the oleosome size and/or reducing the extraneous material bound to the oleosomes, e.g. in the liquid fraction, the lipid-containing composition, and/or the lipids therein;
avoidance a changes on the conformation and/or the native state of the protein in the liquid fraction and/or the protein-containing composition;
increasing the functionality of the protein, such as the foaming properties, e.g. in the liquid fraction, the protein-containing composition, and/or the proteins therein; and/or
increasing the viscoelastic properties, increasing the viscosity and/or increasing the rheological/colloidal properties, e.g. in the liquid fraction, the lipid-containing composition and/or the protein-containing composition.

The term “extraction yield” as used herein refers to the yield of a plant seed-derived composition (e.g. the lipid-, protein, and carbohydrate-containing composition, or other) or plant seed-derived substance (e.g. lipid, protein, carbohydrate, or other) obtained by the method as taught herein. The extraction yield of a plant-seed derived composition is expressed as the amount (L) obtained by the method relative to the initial amount of plant seeds (g). The extraction yield of a plant-seed derived substance is expressed as the percentage difference between its amount (e.g. total amount present in all obtained compositions together, or the amount in one selected composition) obtained by the method as taught herein, relative to the amount in the initial plant seeds.

In a preferred embodiment, step b) as taught herein is preceded by immersing the plant seeds in an aqueous medium (preferably an NaHCO₃ solution as taught herein e.g. with a molarity of 0.05-0.5 mol/L and/or a pH of between 8.5-9.5), having a temperature of between 50-90° C., preferably 60-80° C. (e.g. 70° C.), preferably for a time period of between 5 seconds to 10 minutes, preferably 10 seconds to 5 minutes, more preferably 0.5 and 2 minutes (e.g. 1 minute), herein referred to as the ‘blanching step’.

The blanching step may have one or more of the following effects in the method as taught herein:
increasing the extraction yield of the lipid-containing composition, the protein-containing composition and/or therefore their separation from the carbohydrate-containing composition, and/or increasing the extraction yield of lipid, protein, and/or carbohydrate in total and/or in the respective compositions;
increasing the stability, increasing the shelf-life, reducing the number of micro-organisms, reducing the growth of micro-organisms and/or reducing the enzymatic activity, e.g. in the solid fraction, the liquid fraction, the lipid-containing composition, the protein-containing composition and/or the carbohydrate-containing composition;
facilitate the release of functional components, such as phenolics and/or consequently benefit of their antioxidant activity, e.g. in the solid fraction, in the liquid fraction, in the lipid-containing composition, in the protein-containing composition and/or in the carbohydrate-containing composition;
improving/increasing the cream properties, improving the cream rheological properties, increasing the cream aggregation, avoiding and/or reducing the oleosome damage, reducing the oleosome size and/or reducing the extraneous material bound to the oleosomes, e.g. in the liquid fraction, the lipid-containing composition, and/or the lipids therein;
avoidance a changes on the conformation and/or the native state of the protein in the liquid fraction and/or the protein-containing composition;
increasing the functionality of the protein, such as the foaming properties, e.g. in the liquid fraction, the protein-containing composition, and/or the proteins therein; and/or
increasing the viscoelastic properties, increasing the viscosity and/or increasing the rheological properties, e.g. in the liquid fraction, the lipid-containing composition and/or the protein-containing composition.

In a preferred embodiment, the comminuting as taught herein, e.g. as can be applied in step c) of the method as taught herein, is performed by any one or more of blending, pressing, screw pressing, mixing, homogenising, extruding, and/or grinding.

In a preferred embodiment, the comminuting step as taught herein comprises first immersing the plant seeds in an aqueous medium as taught herein in a seed:aqueous medium ratio of 1:1 (w/w) to 1:12 (w/w), preferably 1:1 (w/w) to 1:10 (w/w), more preferably 1:1 (w/w) to 1:8 (w/w), most preferably 1:1 (w/w) to 1:6 (w/w), based on the weight of the plant seeds and the aqueous medium (following immersing the plants seeds in an aqueous medium as in step b) as taught herein).

The comminuting as taught herein may comprise pressing the plant seeds in a screw press, preferably a twin screw press. This allows one to obtain a press-cake at the end of the screws and a slurry along the screws. The press-cake is preferably the solid fraction and the slurry is preferably the liquid fraction. The twin screw press as taught herein typically is a device in which two screws of progressively reducing pitch rotate. Material entering via the inlet is subjected to gradually increasing pressure as it moves toward the exit end of the press, forcing a concentrated slurry to extrude at the outlet along the screw and a press-cake to extrude at the outlet at the end of the screw. Preferably, the twin screw press as taught herein may be configured such that the mechanical force is between 5 HP (horsepower, wherein one horsepower as used herein is 735.5 watts) and 15 HP, more preferably 6 HP to 14 HP, most preferably 8 to 12 HP (e.g. 10 HP) and/or the length of twin gear between the screws is between 100 mm and 600 mm, and/or the length of screw is between 100 mm and 600 mm, more preferably 130 mm to 300 mm, most preferably 180 mm to 280 mm (e.g. 250 mm) and/or such that the rpm (revolutions per minute) during operation is between 60 rpm to 150 rpm, more preferably 70 rpm to 110 rpm, most preferably 75 rpm to 95 rpm (e.g. 85 rpm), and/or the sieve size is between 50 μm to 1000 μm, more preferably between 200 μm to 800 μm, most preferably between 300 μm to 600 μm.

The lipid fraction obtained in step c) may comprise lipid and protein, in a lipid:protein ratio of between 10:1 (w/w) and 1:10 (w/w), more preferably 5:1 (w/w) to 1:5 (w/w), most preferably 2:1 (w/w) to 1:2 (w/w), all based on the weight of the lipid and/or protein. In addition or alternatively, the liquid fraction obtained in step c) may comprise at least 5, 6, 7, 8, 9, 10, 11, 12, 13, 14, 15, 20, 25, 30, 35 wt % or between 10-70, 20-60 wt. % protein; and/or at least 5, 6, 7, 8, 9, 10, 11, 12, 13, 14, 15, 20, 25, 30, 35 wt. % or between 10-70, 20-60 wt. % lipid. Preferably the liquid fraction comprises less than 70, 60, 50, 40, 30, 20, 10 wt. % carbohydrate. The solid fraction as obtained in step c) may comprise at least 5, 6, 7, 8, 9, 10, 11, 12, 13, 14, 15, 20, 25, 30, 35, 50, 60, 70, 80 wt % or between 40-90, 50-80 wt. % carbohydrate.

In an embodiment, the liquid fraction obtained in step c) in the method as taught herein, preferably the liquid fraction obtained by pressing the plant seeds in a (twin) screw press as disclosed herein, is diluted prior to performing step d) in the method as taught herein. This dilution preferably comprises the addition of aqueous medium as taught herein, preferably an NaHCO₃ solution, or KH₂PO₄, or CaCl₂, as taught herein (e.g. with a molarity of 0.05-0.5 mol/L and/or a pH of between 8-11, or 8.5-9.5). In addition or alternatively, this dilution may be a 1:1-1:50 dilution, or a 1:1-1:25 dilution, or a 1:1-1:10 dilution, or a 1:1-1:5 dilution, or a 1:1-1:4 dilution, or a 1:1-1:3 dilution, or a 1:1-1:2 dilution.

The comminuting as taught herein may comprise or more of blending, pressing, mixing, homogenising, extruding, and grinding, preferably until a slurry is obtained. Subsequently, the liquid fraction (e.g. comprising the protein-containing composition and the protein-containing composition) and the solid fraction (e.g. comprising the carbohydrate-containing composition) present in the slurry may be obtained, e.g. by a separation method as taught herein.

In an embodiment, the solid fraction obtained in step c) as taught herein is further subjected to a treatment to remove water from the solid fraction (e.g. to obtain a carbohydrate-containing composition), for example by one or more of heating, lyophilization, pressing, filtering, straining, pressing, and screw pressing and/or to obtain a water content of the solid fraction (or a carbohydrate-containing composition) of not more than 50 wt. %, preferably not more than 30 wt. %, more preferably not more than 10 wt. %, relative to the total weight of the solid fraction. The drying as taught herein is preferably performed by heating at 25° C. to 75° C., preferably 35° C. to 65° C., more preferably at 55° C. to 60° C. (e.g. until a constant weight of the material is reached).

The separation of the liquid and solid fraction as taught herein (e.g. as present in the slurry as taught herein) may comprise:
(twin) screw pressing to separate the liquid fraction and the solid fraction;
filtering to separate the liquid fraction and the solid fraction, preferably filtering by means of one or more filters with a pore size between 50 μm to 1000 μm, more preferably between 200 μm to 800 μm, most preferably between 150 μm to 500 μm, wherein the liquid fraction is the filtrate and the solid fraction is the remainder.

In a preferred embodiment, step c) of the method as taught herein comprises separating the liquid fraction and the solid fraction by filtering, preferably filtering by means of a filter with pore size between 150 μm to 500 μm. Hence, step c) may involve (twin) screw pressing to comminute and separate the liquid fraction and the solid fraction, or step c) may involve filtering of comminuted plant seeds comprising aqueous medium obtained in step b), preferably filtering by means of one or more filters with a pore size between 50 μm to 1000 μm, more preferably between 200 μm to 800 μm, most preferably between 150 μm to 500 μm, wherein the liquid fraction is the filtrate and the solid fraction is the remainder.

In addition or alternatively, the separation of the liquid fraction and the solid fraction as taught herein may also be performed by (density gradient) centrifugation, preferably at a force of 500×g to 20000×g.

In addition or alternatively, the separation of the liquid fraction and the solid fraction as taught herein may also be performed by one or more of membrane filtration, ceramic filters, basket strainers, clarifiers, decanters, belt filters, e.g. using filters with a pore size between 50 μm to 1000 μm, more preferably between 200 μm to 800 μm, most preferably between 150 μm to 500 μm, wherein the liquid fraction is the filtrate and the solid fraction is the remainder.

In an embodiment, adjusting the liquid fraction as part of step d) in the method as taught herein, is performed by adding an acid and/or an acidic medium such as HCl, KCl, H₂SO₄, CH₃COOH, and/or C₆H₈O₇, for example in a concentration of between 0.01 mol/L to 20 mol/L, preferably between 0.1 mol/L to 15 mol/L, most preferably between 0.1 mol/L to 5 mol/L. Alternatively or in addition, adjustment of the pH of the liquid fraction in step c) may be performed by adding a base and/or basic medium (i.e. alkaline medium) such as comprising NaOH, KOH, and/or NH₄OH, for example in a concentration of between 0.01 mol/L to 20 mol/L, preferably between 0.1 mol/L to 15 mol/L, most preferably between 0.5 mol/L to 5 mol/L.

In an embodiment, adjustment of the pH of the liquid fraction in step d) in the method as taught herein may be performed by adding or combining with an acid or an acidic medium such as HCl, KCl, H₂SO₄, CH₃COOH and/or C₆H₈O₇, in an amount chosen such that it leads to a pH of the liquid fraction of 3.0-8.5, preferably 4.0-7.5, more preferably 5.0-6.5. In addition or alternatively, adjustment of the pH of the liquid fraction in step d) may be performed by adding or combining with a base and/or basic medium (i.e. alkaline medium) such as comprising NaOH, KOH, and/or NH₄OH in an amount chosen such that it leads to a pH of the liquid fraction of 3.0-8.5, preferably 4.0-7.5, more preferably 5.0-6.5.

In a preferred embodiment, step d) in the method as taught herein is performed by adding or combining with an acid and/or acidic (aqueous) medium, preferably (comprising) HCl, CH₃COOH, or C₆H₈O₇, preferably acetic acid.

In a preferred embodiment, step d) in the method as taught herein is followed or preceded by heating the liquid fraction to reach a temperature of between 30-70° C., preferably of between 40-60° C.

Step d) may have one or more of the following effects in the method as taught herein:
increasing the separation of the lipid-containing composition and/or the protein-containing composition;
increasing the stability, e.g. in the solid fraction, the liquid fraction, the protein-containing composition;
increasing the bio-functionality, such as increasing the phenolic content and/or the antioxidant activity, e.g. in the solid fraction, in the liquid fraction, in the lipid-containing composition, in the protein-containing composition and/or in the carbohydrate-containing composition;
increasing the cream properties, increasing the cream aggregation, increasing the oleosome droplet size, reducing the oleosome size and/or reducing the extraneous proteins bound to the oleosomes, e.g. in the liquid fraction, the lipid-containing composition, and/or the lipids therein;
increasing the conformation and/or the native state of the protein in the liquid fraction and/or the protein-containing composition;
increasing the functionality of the protein, such as the foaming properties, e.g. in the liquid fraction, the protein-containing composition, and/or the proteins therein; and/or
increasing the viscoelastic properties, increasing the viscosity and/or increasing the rheological properties, e.g. in the liquid fraction, the lipid-containing composition and/or the protein-containing composition.

In an embodiment, step d) in the method as taught herein facilitates the separation of the aggregated lipids and/or proteins in the liquid fraction in step e) as taught herein. In addition or alternatively, step d) may facilitate separation of the aggregated lipids and/or proteins with reduced centrifugation force and/or with less centrifugation steps in step e) as taught herein.

In addition or alternatively, step d) may facilitate separation of the aggregated lipids and/or proteins in a continuous process in step e) as taught herein.

In an embodiment, step e) in the method as taught herein is performed by:
cream separation, preferably using a cream separator such as a decanter and/or a tricanter; and/or
centrifugation, such as differential centrifugation, density gradient centrifugation, and/or disk centrifugation.

The centrifugation as taught herein, e.g. as part of step e), may be batchwise centrifugation and/or continuous centrifugation, such as batchwise density gradient centrifugation and/or density gradient continuous centrifugation.

The (differential) centrifugation as taught herein, e.g. as part of step e) may be performed at a force of 500×g to 20000×g, preferably 2000×g to 10000×g.

In addition or alternatively, the (differential) centrifugation as taught herein, e.g. as part of step e) may be performed for a period of between 0.5 min to 60 min, preferably 1 min to 40 min, more preferably 5 min to 20 min.

The centrifugation as taught herein (e.g. the differential or disk centrifugation steps) may comprise a single centrifugation step, which is preferably a centrifugation step disclosed herein for step e) as taught herein, or two, three, four, five, or six sequential centrifugation steps. The second, third, fourth, fifth and/or sixth centrifugation steps may be the same or different. In addition or alternatively, the second, third, fourth, fifth and/or sixth centrifugation steps may either or not be a centrifugation step disclosed herein for step e) as taught herein.

The (continuous) density gradient centrifugation such as disk centrifugation as taught herein, e.g. as part of step e) may be performed at:
a force of 500×g to 20000×g, more preferably 1000×g to 1500×g, most preferably 5000×g to 10000×g:
a capacity of 10-1000 L/h;
a discharge interval of 10-1000 sec, preferably 150-350 sec; and/or
a backpressure of 0.5-5 bar, preferably 1-3 bar.

In an embodiment of the current disclosure, (continuous) density gradient centrifugation such as disk centrifugation is performed with a capacity of more than 100 L/h, 200 L/h, 500 L/h, 1000 L/h, 2000 L/h, 5000 L/h, 10000 L/h, 50000 L/h, or more than 100000 L/h. In addition or alternatively, (continuous) density gradient centrifugation such as disk centrifugation is performed a capacity of less 100000 L/h, 50000 L/h, 10000 L/h, 5000 L/h, 2000 L/h, 1000 L/h, 500 L/h, 200 L/h or 100 L/h.

In a preferred embodiment, step e) as taught herein is performed by batch-wise density gradient centrifugation at a force of 500×g to 10000×g, more preferably 1000×g to 7500×g, most preferably 2000×g to 5000×g, and preferably for a period of 1 minute to 20 minutes, preferably 5 minutes to 10 minutes, wherein the liquid fraction is preferably the fraction that is comprised in suspension after centrifugation and the solid fraction is the fraction that is comprised in the sediment after centrifugation.

In another preferred embodiment, step e) as taught herein is performed by continuous density gradient centrifugation such as disk centrifugation, preferably at a force of 500×g to 20000×g, more preferably 1000×g to 1500×g, most preferably 5000×g to 10000×g, and preferably at a capacity of 10-1000 L/h, wherein the liquid fraction is preferably the fraction that is comprised in suspension after centrifugation and the solid fraction is the fraction that is comprised in the sediment after centrifugation.

In an embodiment, step e) in the method as taught herein is performed in a total time of in between 1 minute and 2 hours, preferably of in between 1 minute and 1 hour, more preferably of in between 1 minute and 30 min, most preferably of in between 1 minute and 20 min, and/or is performed in a continuous process.

In addition or alternatively, step e) in the method as taught herein is performed in a total time of in between 1 minute and 2 hours, preferably of in between 1 minute and 1 hour, more preferably of in between 1 minute and 30 min, most preferably of in between 1 minute and 20 min, and/or is performed in a continuous process, wherein the total time is:
per kg, per 10 kg, per 100 kg, per 1000 kg, per 10000, per 100000 kg, or per 1000000 kg of plant seeds provided in step a) in the method as taught herein; and/or
per L, per 10 L, per 100 L, per 1000 L, per 10000 L, per 100000 L, or per 1000000 L, wherein the volume is the capacity of an apparatus used to perform step e) in the method as taught herein.

In one aspect, the current invention relates to a product, preferably as obtainable or obtained by the method as taught herein, wherein the product preferably is or is derived from the protein-containing composition obtained by the method as taught herein:
containing at least 50 wt. % protein, or 60 wt. % protein, preferably at least 70 wt. % protein;
containing 1 wt. % to 40 wt. % carbohydrate, e.g. 2 wt. % to 35 wt. % carbohydrate or 5 wt. % to 20 wt. % carbohydrate, and/or containing less than 40 wt. %, less than 35 wt. %, less than 20 wt. %, or less than 10 wt. % carbohydrate;
containing 5 wt. % to 65 wt. % lipid, e.g. 15 wt. % to 55 wt. % lipid or 25 wt. % to 45 wt. % lipid, and/or containing less than 80 wt. %, less than 60 wt. %, less than 40 wt. %, or less than 20 wt. % lipid;
containing less than 5 wt. % ashes, preferably less than 2 wt. % ashes, or less than 1% ashes, preferably less than 0.5% ashes, more preferably less than 0.2% ashes;
containing less than 0.05 wt. % erucic acid, preferably less than 0.005 wt. % erucic acid;
containing less than 5 wt. %. glucosinolate, preferably less than 2 wt. %, more preferably less than 1 wt. %, most preferably less than 0.5 wt. %;
having a total phenolic content of 10 to 70, preferably 20 to 60, more preferably 30 to 50, expressed as mg gallic acid equivalent (GAE)/g of product; and/or
having an antioxidant capacity of 20 to 160, preferably 40 to 140, more preferably 60 to 120, most preferably 80 to 100, expressed as % singlet oxygen radical scavenging capacity,
wherein the protein, carbohydrate and lipid preferably are (derived) from one or more plant seeds as disclosed herein, more preferably from one or more oil-rich plant seeds as disclosed herein,
wherein said product preferably does not contain added texturizers, emulsifiers and/or added antioxidants, and/or wherein said product preferably contains at most 5, 4, 3, 2, 1 wt. % added texturizers, added emulsifiers, or added antioxidants.

Weight percentages preferably are with respect to dry weight. The drying as taught herein is preferably performed by heating at 25° C. to 90° C., preferably 35° C. to 65° C., more preferably at 55° C. to 60° C. (e.g. until a constant weight of the material is reached and/or for 1, 2, 3 hours). The product is suitable as food, feed, cosmetic, supplement, and/or pharmaceutical product.

In an embodiment, the current disclosure relates to a product containing at least 65 wt. % protein derived from an oil-rich plant seed as disclosed herein (e.g. rapeseeds, canola seeds and/or sunflower seeds) and having less than 0.2% ashes.

In an embodiment, the current disclosure relates to a product containing at least 35 wt. % protein derived from an oil-rich plant seed as disclosed herein (e.g. rapeseeds, canola seeds and/or sunflower seeds) and having less than 0.2% ashes.

The term ‘ashes’ as used herein relates to the residues after a food product is completely burnt and/or digested. The ashes or the constituent of ashes include, but are not limited to potassium, sodium, calcium and magnesium, aluminum, iron, copper, manganese or zinc, arsenic, iodine, fluorine and other elements present in traces. In the present disclosure, moisture, ash, and fatty acids are preferably measured using an ISTISAN protocol (ISTISAN Report 1996/34, pages 77-78).

In one aspect, the current invention relates to a product, preferably obtainable or obtained by the method as taught herein, wherein the product preferably is or is derived from the lipid-containing composition obtained by the method as taught herein:
containing at least 65 wt. % lipid, or at least 70 wt. % lipid, or at least 80 wt. % lipid, preferably at least 85 wt. % lipid;
containing 5 wt. % to 50 wt. % protein, e.g. 10 wt. % to 40 wt. % protein or 15 wt. % to 30 wt. % protein, and/or containing less than 50 wt. %, less than 30 wt. %, less than 20 wt. %, less than 10 wt. %, or less than 5 wt. % protein;
containing 5 wt. % to 20 wt. % carbohydrate, e.g. 2 wt. % to 10 wt. % carbohydrate or 1 wt. % to 5 wt. % carbohydrate, and/or containing less than 20 wt. %, less than 10 wt. %, less than 5 wt. %, less than 2 wt. %, or less than 1 wt. % carbohydrate;
containing less than 5 wt. % ashes, or less than 2 wt. % ashes, or less than 1% ashes, or less than 0.5% ashes, preferably less than 0.2% ashes;
containing less than 0.05 wt. % erucic acid, preferably less than 0.005 wt. % erucic acid;
containing less than 5 wt. %. glucosinolate, preferably less than 2 wt. %, more preferably less than 1 wt. %, most preferably less than 0.5 wt. %;
having a total phenolic content of 10 to 70, preferably 20 to 60, more preferably 30 to 50, expressed as mg gallic acid equivalent (GAE)/g of product; and/or
having an antioxidant capacity of 20 to 160, preferably 40 to 140, more preferably 60 to 120, most preferably 75 to 95, expressed as % singlet oxygen radical scavenging capacity,
   wherein the protein, carbohydrate and lipid preferably are (derived) from one or more plant seeds as disclosed herein, more preferably from one or more oil-rich plant seeds as disclosed herein,
   wherein the product is preferably vegan mayonnaise, preferably full fat vegan mayonnaise or light vegan mayonnaise,
   wherein said product preferably does not contain added texturizers, emulsifiers and/or added antioxidants, and/or wherein said product preferably contains at most 5, 4, 3, 2, 1 wt. % added texturizers, added emulsifiers, or added antioxidants.

Weight percentages preferably are with respect to dry weight. The drying as taught herein is preferably performed by heating at 25° C. to 90° C., preferably 35° C. to 65° C., more preferably at 55° C. to 60° C. (e.g. until a constant weight of the material is reached and/or for 1, 2, 3 hours). The product is suitable as food, feed, cosmetic, supplement, and/or pharmaceutical product.

Phenolic content is some embodiments preferably is not too high (but balanced). Phenolic content is related to bitterness.

In an embodiment, the current disclosure relates to a product containing at least 85 wt. % lipid derived from an oil-rich plant seed as disclosed herein (e.g. rapeseeds, canola seeds and/or sunflower seeds) and having less than 0.2% ashes.

In an embodiment, the current disclosure relates to a product containing at least 90 wt. % lipid derived from an oil-rich plant seed as disclosed herein (e.g. rapeseeds, canola seeds and/or sunflower seeds) and having less than 0.2% ashes.

In one aspect, the current invention relates to a product, preferably obtainable or obtained by the method as taught herein, wherein the product preferably is or is derived from the carbohydrate-containing composition obtained by the method as taught herein:
containing at least 20 wt. % carbohydrate, or at least 40 wt. % carbohydrate, or at least 50 wt. % carbohydrate, preferably at least 60 wt. % carbohydrate, more preferably at least 80 wt. % carbohydrate;
containing 5 wt. % to 60 wt. % protein, e.g. 15 wt. % to 50 wt. % protein or 25 wt. % to 40 wt. % protein, and/or containing less than 50 wt. %, less than 40 wt. %, less than 30 wt. %, less than 20 wt. %, or less than 10 wt. % protein;
containing 0.1 wt. % to 9 wt. % lipid, e.g. 0.3 wt. % to 7 wt. % lipid or 0.5 wt. % to 5 wt. % lipid, and/or containing less than 10 wt. %, less than 5 wt. %, less than 2 wt. %, less than 1 wt. %, or less than 0.5 wt. % lipid;
containing less than 7 wt. % ashes, preferably less than 5 wt. % ashes, more preferably less than 4% ashes, even more preferably less than 3% ashes, most preferably less than 2% ashes;
containing less than 0.05 wt. % erucic acid, preferably less than 0.005 wt. % erucic acid;
containing less than 5 wt. %. glucosinolate, preferably less than 2 wt. %, more preferably less than 1 wt. %, most preferably less than 0.5 wt. %;
having a total phenolic content of 10 to 70, preferably 20 to 60, more preferably 20 to 40, expressed as mg gallic acid equivalent (GAE)/g of product; and/or
having an antioxidant capacity of 20 to 160, preferably 40 to 140, more preferably 50 to 120, most preferably 60 to 80, expressed as % singlet oxygen radical scavenging capacity,
   wherein the protein, carbohydrate and lipid preferably are (derived) from one or more plant seeds as disclosed herein, more preferably from one or more oil-rich plant seeds as disclosed herein.

Weight percentages preferably are with respect to dry weight. The drying as taught herein is preferably performed by heating at 25° C. to 90° C., preferably 35° C. to 65° C., more preferably at 55° C. to 60° C. (e.g. until a constant weight of the material is reached and/or for 1, 2, 3 hours). The product is suitable as food, feed, cosmetic, supplement, and/or pharmaceutical product.

In an embodiment, the current disclosure relates to a product containing at least 25 wt. % carbohydrate derived from an oil-rich plant seed as disclosed herein (e.g. rapeseeds, canola seeds and/or sunflower seeds) and having less than 0.2% ashes.

In the present disclosure, the lipid content is preferably determined using the Marsh and Weinstein assay performed at 20° C. (Marsh et al. J Lipid Res. 1966 July; 7(4):574-6). For example, the protocol may be (similar to) the following: concentrated sulfuric acid, tested for the presence of organic residues by heating at 200° C. for 5 min, is used. The standard solutions are prepared in chloroform at a concentration of 30-50 pg/ml and aliquots of 1-10 ml are generally employed in the assay. Solvents are removed from the lipid samples under a flow of nitrogen in test tubes placed in an aluminum heating block at 80-100° C. After the tubes have been cooled, 2 ml of concentrated sulfuric acid is added to each tube. At 15 sec intervals the tubes are placed in an aluminum heating block at 200° C. for 15 min. The temperature within the tubes in the heating block should be controlled to within 20° C. during the charring period. The tubes are placed in water at room temperature for 15 sec and then are transferred to an ice bath for 5 min; 3 ml of water is added to each tube, the contents are mixed thoroughly, and the tubes are replaced in the ice bath. When cool, the tubes are removed from the ice and left standing for 10-15 min or until all bubbles have disappeared.

The optical density is measured with a spectrophotometer at 375 mμ. This wavelength was selected to achieve near maximum sensitivity with the spectrophotometer employed. In the present disclosure, the amount of lipid is preferably expressed as % of the lyophilised product, wherein the lyophilisation is performed at −40° C. for 12-24 hours on a sample of 50 g.

In the present disclosure, the protein content is preferably determined using the Lowry protein assay performed at 20° C. (Lowry et al. J Biol Chem. 1951 November; 193(1):265-75). For example, the protocol may be (similar to) the following:
Solution A and solution B are prepared, wherein solution A contains 4 mg/mL NaOH and 20 mg/mL Na₂CO₃ in water and wherein solution B contains 10 mg/mL Potassium Sodium Tartrate and 5 mg/mL CuSO₄ in water. Solutions A and B are mixed (e.g. 50:1 mix of solutions A and B, this is called Lowry's solution);
Protein standards are made (e.g. using bovine serum albumin).
Samples are prepared by adding 2, 5, and 10 μL of sample containing protein into a glass tube and total volume is adjusted to 200 μL;
To each tube, add 1 mL Lowry's Solution, vortex, wait 15 min;
To each tube add 100 μL 1.0 N Folin's Phenol reagent;
Measure absorbance at 750 nm.

In the present disclosure, the amount of protein is preferably expressed as % of the lyophilised product, wherein the lyophilisation is performed at −50° C. for 12 hours on a sample of 50 g.

In the present disclosure, the carbohydrate content is preferably determined using the Dubois assay performed at 20° C. (Dubois et al. Analytical Chemistry, 28: 350-356, 1956). For example, the protocol may be (similar to) the following:
Take 200 μL of sample in a 1.5 mL tube;
Add 200 μL 5% phenol;
Rapidly add 1 mL of concentrated sulfuric acid, invert 3 times or briefly vortex to mix;
Let stand for at least 60 minutes before transferring to cuvette;
Take absorbance readings at 490 nm and 1000 nm (subtract noise) using a spectrophotometer;
Normalized to a standard curve with known amount of carbohydrate.

In the present disclosure, the amount of carbohydrate is preferably expressed as % of the lyophilised product, wherein the lyophilisation is performed at −50° C. for 12 hours on a sample of 50 g.

In the present disclosure, the total phenolic content is expressed as mg/GAE (gallic acid equivalent) g of lyophilized product as measured by the Folin-Ciocalteu assay. For example, the protocol may be (similar to) the following:
500 μL of different concentrations-depending on solubility-sample in water is mixed with 2.5 mL of Folin-Ciocalteu reagent (0.2 N). After 5 min, 2 mL of Na₂CO₃ solution (75 g/L) is added. After 60 min standing in dark, the optical density is measured at 760 nm against a blank. The total phenolic content is calculated on the basis of the calibration curve of gallic acid and expressed as gallic acid equivalents (GAE), in milligrams per gram of the sample.

In the present disclosure, the antioxidant activity, is preferably measured by the 2,2-diphenyl-1-picrylhydrazyl (DPPH) assay (Rajauria et al. Journal of Food Biochemistry 37(3) 2012). For example, the protocol may be (similar to) the following:

The assay is performed in a 96-well round-bottomed microtiter plate with 1:1 (v/v) ratio of 100 mL of DPPH radical solution (165 mM) and 100 mL of sample. Different concentrations are tested for each sample in order to get the % of singlet oxygen radical scavenging capacity. The DPPH solution is freshly prepared for each experiment in methanol. The reaction mixtures are incubated for 30 min at 25° C. in dark conditions, and absorbance is measured at 517 nm in a microtiter plate reader. The ability to scavenge the DPPH radical is calculated using the equation: scavenging capacity (%)=1−[(Aₛₐₘₚₗₑ−A_{sample blank})/(A_{control})], where A_{control} is the absorbance of the control (DPPH solution without sample), Aₛₐₘₚₗₑ is the absorbance of the test sample (DPPH solution plus test sample) and Aₛₐₘₚₗₑ blank is the absorbance of the sample only (sample without any DPPH solution). Calculated values indicate the concentration of sample required to scavenge DPPH radicals (expressed as %). The higher % value of the sample, the higher antioxidant capacity.

The terms ‘comprising’ or ‘to comprise’ and their conjugations, as used herein, refer to a situation wherein said terms are used in their non-limiting sense to mean that items following the word are included, but items not specifically mentioned are not excluded. It also encompasses the more limiting verb ‘to consist essentially of’ and ‘to consist of’.

Reference to an element by the indefinite article ‘a’ or ‘an’ does not exclude the possibility that more than one of the elements is present, unless the context clearly requires that there be one and only one of the elements. The indefinite article ‘a’ or ‘an’ thus usually means ‘at least one’.

The terms ‘to increase’ and ‘increased level’ and the terms ‘to decrease’ and ‘decreased level’ refer to the ability to significantly increase or significantly decrease or to a significantly increased level or significantly decreased level. Generally, a level is increased or decreased when it is at least 5%, such as 10%, 15%, 20%, 25%, 30%, 35%, 40%, 45%, 50% higher or lower, respectively, than the corresponding level in a control or reference. Alternatively, a level in a sample may be increased or decreased when it is statistically significantly increased or decreased compared to a level in a control or reference. Weight percentages (wt. %) as used herein are with respect to the total weight of the respective composition/fraction/product.

### DESCRIPTION OF FIGURES

FIG. 1. Total ion chromatograms (TICs) of rapeseed seeds obtained by gas chromatography-mass spectrometry (GC-MS). The fatty acids content and profile are further provided in Table 2.

FIG. 2. Effect of soaking time and temperature on lipid aggregation. Canola seeds were blanched for 1 min in a solution heated to 70° C. This was followed by a soaking step, which was either performed for 8 h at 25° C. (left image), or for 4 h at 40° C. (right image). Following soaking, the seeds were comminuted to a slurry by blending. The liquid fraction was obtained as the filtrate when passing the slurry through a filter. The pH of the liquid fraction was adjusted to pH 6.0 by adding a 5 M HCl solution. Lipid aggregation was determined with respect to the thickness of the condensed cream layer formed at the top of the suspension. The blanching, soaking, and blending steps were all performed in a 0.1 M sodium bicarbonate solution.

FIG. 3. Effect of pH adjustment of the canola-derived liquid fraction on lipid aggregation. Canola seeds were blanched for 1 min at 70° C. This was followed by a soaking step for 1 h at 60°. The hydrated seeds were comminuted to a slurry by blending. The liquid fraction was obtained as the filtrate when passing the slurry through a filter. The pH was adjusted to 5.5, 7.0 or 8.5 by adding a 5 M HCl solution. Lipid aggregation was determined with respect to the thickness of the condensed cream layer formed at the top of the suspension. The images were taken 1 second (top image), 6 seconds (middle image) or 15 seconds (bottom image) after the pH adjustment. The blanching, soaking, and blending steps were all performed in a 0.1 M sodium bicarbonate solution.

FIG. 4. Effect of pH adjustment of the canola seed-derived liquid fraction on lipid aggregation. Canola seeds were blanched for 1 min at 70° C. This was followed by a soaking step for 1 h at 60°. The hydrated seeds were comminuted to a slurry by screw pressing. The liquid fraction was obtained as the filtrate when passing the slurry through the filter attached to the screw press. The pH was adjusted to 5.5, 6.0, 6.5 or 7.0 by adding a 5 M HCl solution. Lipid aggregation was determined with respect to the thickness of the condensed cream layer formed at the top of the suspension. The image provided was taken after centrifugation of the material at 3600 g for 5 minutes. The blanching, soaking, and blending steps were all performed in a 0.1 M sodium bicarbonate solution. This image was reported as proof that the separation of the lipid-containing composition and the protein-containing composition was aid by the pH adjustment.

FIG. 5. Effect of pH adjustment of the sunflower seed-derived liquid fraction on lipid aggregation. Sunflower seeds were blanched for 1 min at 70° C. This was followed by a soaking step for 1 h at 60°. The hydrated seeds were comminuted to a slurry by blending. The liquid fraction was obtained as the filtrate when passing the slurry through a filter. The pH was adjusted to 6.0 or 8.5 by adding a 5 M HCl solution. Lipid aggregation was determined with respect to the thickness of the condensed cream layer formed at the top of the suspension. The image was taken 30 minutes after adjusting the pH. The blanching, soaking, and blending steps were all performed in a 0.1 M sodium bicarbonate solution.

### EXPERIMENTAL SECTION

### Example 1

### Background

This experimental section shows the aqueous fractionation method from which a lipid-enriched fraction, a protein-enriched fraction and a carbohydrate-enriched fraction is obtained from plant seeds. As such, it highlights how the inclusion of previously unknown steps—foremost a specific and pH adjustment step, among others—are particularly advantageous for the yield and industrial applicability when using the fractionation method. The results obtained for canola seeds and sunflower seeds are provided herein as example, however the current fractionation method can be extrapolated to other related types of seeds.

### Methods

### Seeds

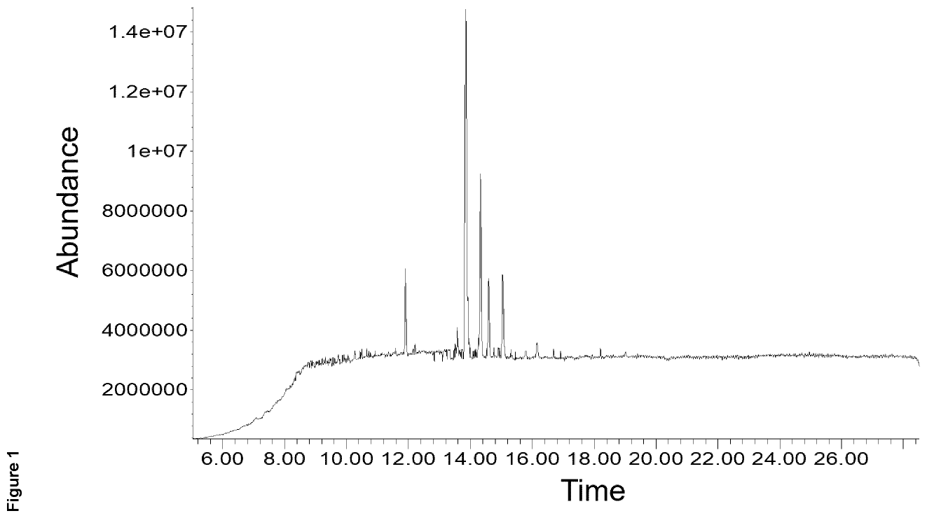

Different varieties of seeds were considered for the current fractionation method. These seeds were analysed for their biochemical composition (carbohydrates, proteins, lipids, and ashes). Breed of rapeseed low in antinutritional factors, Brassica napus variety (hereafter canola) and Helianthus annuus sunflower seed presented the most balanced biochemical composition (as provided in Table 1) and fatty acid profile (as provided in FIG. 1 and Table 2), were selected to exemplify the current fractionation method.

TABLE 1
Biochemical composition of canola and sunflower seeds used in
the present process. Data are expressed as % of analysed seeds.
Values are expressed as mean ± standard deviation (n = 3).

| Fraction\hat{ } | Carbohydrates | Proteins | Lipids | Ashes | Moisture |
|---|---|---|---|---|---|
| Canola seed | 14.66 ± | 24.92 ± | 49.46 ± | 3.21 ± | 1.08 ± |
| | 1.09 | 0.52 | 4.74 | 2.68 | 0.35 |
| Sunflower | 20.00 ± | 20.88 ± | 51.57 ± | 4.46 ± | 0.34 ± |
| seed* | 0.54 | 0.86 | 1.73 | 0.29 | 0.12 |

\hat{ }Both seeds contained less than 0.01 g of salt
*Sunflower seeds also contained 325 mg of magnesium (equivalent to 87% of the Nutrient Reference Values, NRVs).

TABLE 2
Fatty acid content and profile (% of dry weight, w/w) detected
by gas chromatography-mass spectrometry (GC-MS) of the canola
seeds. Values are expressed as mean ± standard deviation (n = 3).

| Fatty acid | (%, w/w) |
|---|---|
| C12:0 | — |
| C14:0 | — |
| C16:0 | 2.92 ± 0.37 |
| C18:0 | 0.70 ± 0.22 |
| Other SFA | — |
| Σ SFA | 3.62 |
| C16:1 ω7 | — |
| C18:1 ω9 | 20.42 ± 1.10 |
| Other MUFA | — |
| Σ MUFA | 20.42 |
| C16:3 ω3 | — |
| C16:4 ω3 | — |
| C18:3 ω3 (ALA) | 3.43 ± 0.10 |
| C20:5 ω3 (EPA) | — |
| C22:6 ω3 (DHA) | — |
| Other PUFA ω3 | — |
| ΣPUFA ω3 | 3.43 |
| C16:2 ω6 | — |
| C18:2 ω6 (LA) | 6.53 ± 0.20 |
| C18:3 ω6 (GLA) | — |
| C20:2 ω6 | — |
| C20:4 ω6 (ARA) | — |
| Other PUFA ω6 | — |
| ΣPUFA ω6 | 6.53 |
| ΣPUFA ω3 + ω6 | 9.96 |
| TFA | 34.0 |

SFA Saturated fatty acids, MUFA Monounsaturated fatty acids, PUFA Polyunsaturated fatty acids, TFA Total fatty acids, ALA Alpha-linolenic acid, EPA Eicosapentaenoic acid, DHA Docosahexaenoic acid, LA Linoleic acid, GLA Gamma-linolenic acid, ARA Arachidonic acid

### Blanching

As part of the blanching treatment, the seeds were submerged in a bicarbonate solution (0.1 M, pH 9.5) kept at a constant temperature of 70° C. After 1 min, the seeds were recovered and the sodium bicarbonate solution was discarded. Bacterial presence in terms of the colony-forming units (CFU) was evaluated by the bacterial plate count method.

### Soaking

Following blanching, the seeds were submerged in a fresh sodium bicarbonate solution (0.1 M, pH<9.5) having a volume corresponding to the initial weight of the seeds (1:1). The effects of heating time and temperature were studied by treating the seeds in the solution under the following three conditions:
1) overnight at room temperature
2) 4 h at 40° C., or
3) 1 h at 60° C.

Bacterial presence was determined as aforementioned. Moreover, the effects of the soaking conditions on the extraction yield of the three fractions and on the lipid aggregation were determined.

### Comminution

The third step of the fractionation method included comminuting the loosened/hydrated seed cell walls by either blending or twin-screw pressing.

The blending step involved adding a fresh solution of sodium bicarbonate (0.1 M, pH 9.5) to obtain a ratio of 1:4 (1 part of initial dried seeds and 4 parts of sodium bicarbonate solution). The mixture was then carefully homogenised in a blender for 60 second at the maximum speed (blender with a motor of 400 W) or medium speed (blender with a motor of 800 W). After the blending, the mixture was filtered using 1 layer of thick cheesecloth of 2 layers of thin one (about 150 μm pore size). The resulting solid fraction (i.e. the carbohydrate-enriched fraction) that was entrapped in the cheesecloth was manually recovered and dried at 50-60° C. for 4 hours until constant weight. The filtrate or liquid fraction that passed through the cheesecloth was used in the next steps of this process.

The twin-screw pressing step involved adding the loosened/hydrated seeds directly to the twin-screw press without further dilution. Two streams were recovered from the twin-screw press: one stream which was the solid fraction (i.e. the carbohydrate-enriched fraction) that was recovered at the end of the screws, and the other stream is the slurry-like liquid fraction which was recovered along the screws. The solid fraction recovered at the end of the screws was optionally dried at 50-60° C. for 4 h until constant weight. The liquid fraction recovered was re-diluted in a sodium bicarbonate solution (0.1 M, pH 9.5) to obtain a ratio of 1:4 (1 part of initial dried seeds and 4 parts of sodium bicarbonate solution).

### pH Adjustment

The pH of the liquid fraction obtained either by blending or twin-screw pressing was adjusted with the aid of an HCl solution (5 M). The effect of the adjusted pH of the liquid fraction (ranging between 5.5 and 8.5) on the extraction yield of the three fractions and on the aggregation of the lipid fraction, were determined.

### Centrifugation

After the pH adjustment, the liquid fraction was subjected to centrifugation to separate the protein-enriched and lipid-enriched fractions. The liquid fraction was divided into 15 mL falcons and then centrifuged at 3600×g for 10-12 min.

An optional step before the centrifugation step was the pre-heating of the liquid fraction to a temperature of 40-60° C. (preferably 50° C.). For this purpose, the falcons containing the liquid fractions were submerged in a bowl with water until the desired temperature of the liquid fraction was reached.

### Characterizations of Obtained Fractions

Total protein was analysed following Lowry et al. (Lowry et al. J Biol Chem. 1951 November; 193(1):265-75). Carbohydrate and lipid were quantified according to Dubois et al. (Dubois et al. Analytical Chemistry, 28: 350-356, 1956) and Marsh and Weinstein (Marsh et al. J Lipid Res. 1966 July; 7(4):574-6), respectively. Moisture, ash, and fatty acids were analysed using ISTISAN protocols (ISTISAN Report 1996/34, method B, page 7 and ISTISAN Report 1996/34, pages 77-78, ISTISAN Report 1966/34, page 47-59 and 173-175, respectively. All the obtained fractions were also characterized for their total phenolic content using the Folin-Ciocalteu assay (Ganesan et al. Bioresour Technol. 2008; 99:2717-27238) and for the antioxidant capacity using the 2,2-diphenyl-1-picryl-hydrazyl-hydrate (DPPH) assay (Rajauria et al. Journal of Food Biochemistry 37(3) 2012).

Glucosinolate content in canola-derived fractions was measured using ISO 9167-1:1992; AOCS Ak 1-92. Phytic acid content in canola-derived fractions was measured using the method reported by Ellis et al. (Ellis, R., Morris, E. R., & Philpot, C. 1977. Quantitative determination of phytate in the presence of high inorganic phosphate. Analytical Biochemistry, 77(2), 536-539).

### Results/Discussion

### Blanching

It was found that blanching for 1 min at 70° C. improved the stability and shelf-life of the obtained fractions. It is generally assumed that a heating step should be avoided as it is believed to denature proteins, however the denaturation of proteins was not observed by the current inventors when the blanching step at 70° C. was limited to only 2, preferably 1 minute.

The extraction yield of the three fractions and lipid aggregation were not affected using the current blanching step. Therefore, the specific combination of time and temperature may be optimal to achieve the desired result. The specific combination of time (1 min) and temperature (70° C.) resulted in an unexpected improvement in stability and shelf-life of the fractions as compared to longer blanching times at lower temperatures. Moreover, the specific time chosen resulted in an improvement in the enriched fractions with more stable biochemical composition profiles as compared to other blanching temperatures.

### Soaking

Soaking is typically performed to loosen up, hydrate and/or solubilize the components in the seeds. The literature (e.g. De Chirico et al. Food Chem. 2018 Feb. 15; 241:419-426, Romero-Guzmán et al. Food and Bioproducts Processing. Volume 121, May 2020) stresses the need of a soaking time of at least 8 h, and generally between 16 to 24 hours. This significantly delays the process, leads to waste of energy, and increases the chance of microbial growth, among the many other possible limitations. Moreover, it is generally assumed that a heating step should be avoided as it is believed to denature proteins, therefore soaking steps are typically performed at room temperature.

Surprisingly, the current inventors showed that as the soaking times decreased and the temperature increased, a reduction of the bacteria present was obtained. The seeds soaked for 1 h at 60° C. showed the least bacterial growth, which was furthermore neglectable (2 CFU/mL). After 1 h, the sodium bicarbonate solution was already completely absorbed by the seeds, demonstrating sufficient hydration at this point to proceed with the comminution step.

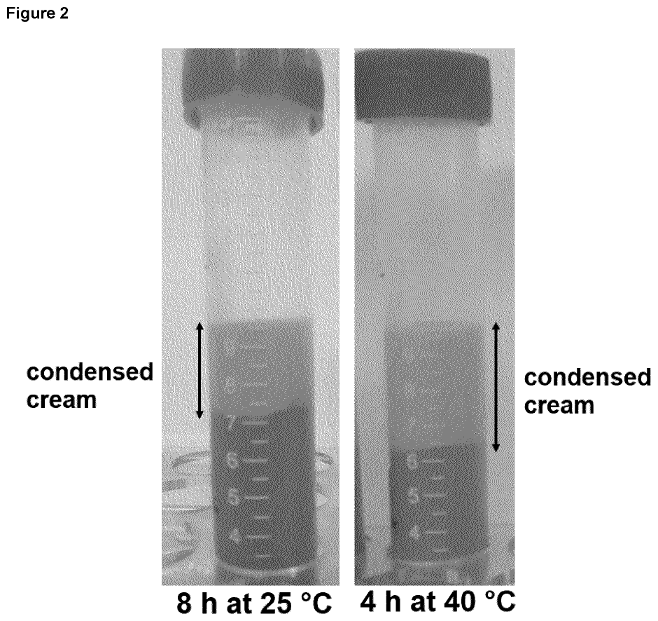

Furthermore, it was found that a shorter soaking time at higher temperature did not affect the extraction yield of the protein- and carbohydrate-enriched fractions. These findings contrast the general presumption that a heating step should be avoided as to avoid denaturation of proteins, among others. An improved cream condensation is considered to be important, as it determines the success amount of cream recovered after centrifugation. The current inventors showed that soaking at the specific combination (i.e. for 1 h at 60°) may surprisingly enhance the extraction yield of the lipid fraction in the form of condensed cream (FIG. 2). The optimal soaking condition was therefore established by the current inventors to be 1 h at 60° C., considering the lowest amount of bacteria present seen at this condition, the favourable yield of the three fractions, and improved formation of the condensed cream.

### pH Adjustment

In addition to the novel soaking step, the pH adjustment disclosed hereafter was identified by the current inventors as a highly advantageous step to accelerate and improve the aggregation of lipids in the form of a condensed cream. Moreover, an optimal cream condensation may support the current protocol to be translated to a better separation of the lipid-, protein-, and carbohydrate-enriched fractions using a large scale centrifugation method. For example, preferably a continuous processing method is used such as disk centrifugation instead of a lab scale batch-to-batch processing method.

Similar extraction protocols applied on plant seeds are generally performed entirely at alkaline conditions, which is normally required to increase the solubility and release of proteins that become negatively charged (De Chirico et al. Food Chem. 2018 Feb. 15; 241:419-426), or low acidic conditions which have a similar effect (Romero-Guzmán et al. LWT—Food Science and Technology 123 (2020) 109120).

Incidentally, the current inventors found that a switch from alkali pH to a neutral or closer to neutral pH (e.g. between 4.0 and 6.5) of the liquid fraction may lead to far superior separation of the protein- and lipid-enriched fractions. Moreover, the timing when this pH adjustment step is applied, i.e. specifically prior to liquid-liquid separation but after liquid solid-separation, needs to be considered. The specific pH adjustment then leads to the recovery of a concentrated cream which is rich in oleosomes and which renders the proteins towards a native state.

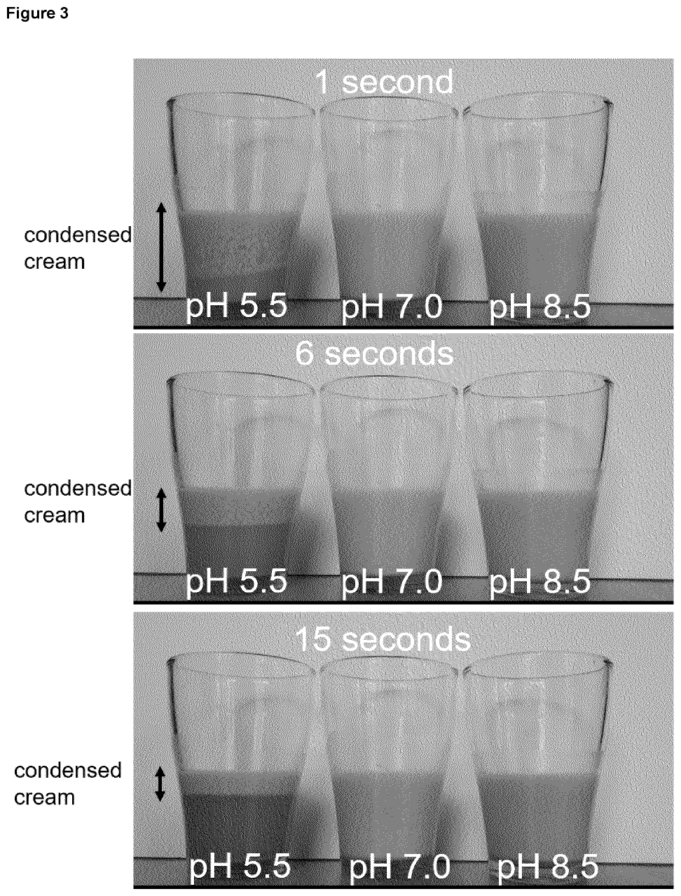

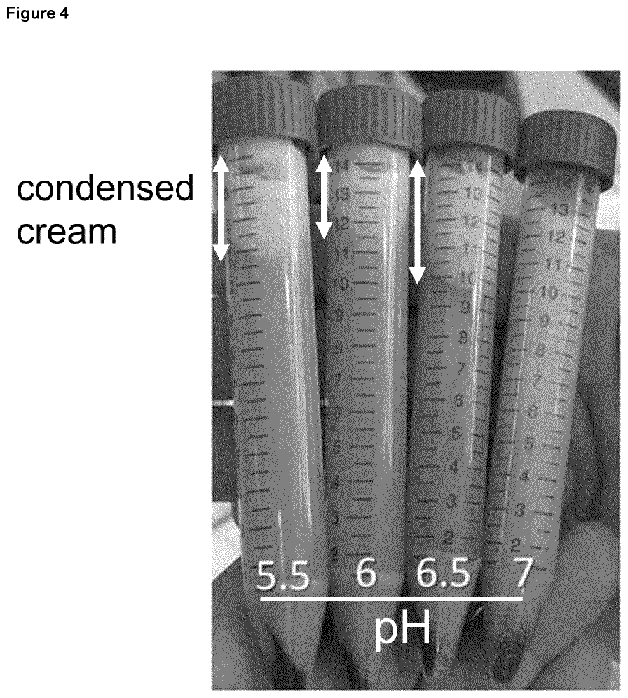

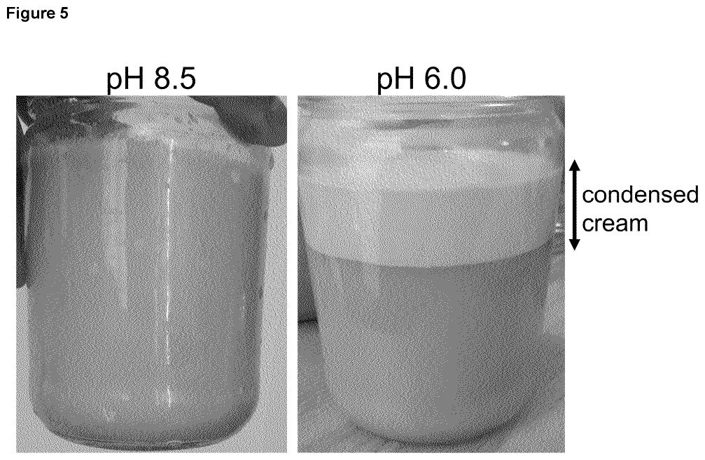

As shown in FIG. 3, adjustment of the pH of a canola seed-derived liquid fraction to a pH of between pH 5.5 and pH 6.5 strongly reduced the time needed for the material to cream. Surprisingly, at the pH of 5.5, the formation of a condensed cream was already observed within seconds, whereas this was not seen for a pH of 7.0 or higher. As shown in FIG. 4, when the canola seed-derived liquid fraction was left to rest for 30 minutes prior to centrifugation, a high-quality condensed cream was only seen in the optimal pH range of 5.5-6.5, whereas no condensed cream was seen for a pH above 6.5. A similar results were obtained using sunflower seed. As shown in FIG. 5, a more condensed and improved cream is seen at pH 6.0 when the liquid fraction is left to rest for 30 minutes prior to centrifugation. In comparison, no condensed cream is seen at pH 8.5. The alkaline conditions was furthermore yielded a bright yellow suspension which is an indication of polyphenols oxidation and/or interactions of polyphenols and proteins.

### Centrifugation

In scientific papers, the conventionally g forces used to recover the condensed cream is set at a relatively high forces, that is, typically 10,000×g or more. The high forces are generally needed to increase the amount of cream recovered, e.g. if there is suboptimal lipid aggregation (De Chirico et al. Food Chem. 2018 Feb. 15; 241:419-426, Romero-Guzmán et al. Food and Bioproducts Processing. Volume 121, May 2020). Moreover, multiple centrifugation and washing steps are normally needed, which is circumvented by including the novel steps in the current fractionation method.

The improved cream condensation achieved by the novel pH adjustment step was found to favour the recovery of the lipids and proteins in the liquid fraction by centrifugation. Following pH adjustment to preferably pH 5.5-6.5, the (aggregated) protein and (aggregated) lipid could be successfully performed at a lower centrifugation force, e.g. between 1500 and 5000×g. Moreover, a single centrifugation step was found to suffice.

The novel pH adjustment step furthermore also enables/facilitates large scale centrifugation methods to separate the enriched fractions by the current method. These large scale centrifugation methods such as disk centrifugation or other continuous processing methods, are generally performed a lower centrifugation forces (e.g. well below 10,000×g). Comparable separation methods to the one as disclosed herein, only suitable for batch centrifugation and at very high g forces (e.g. around 10,000×g or higher). The experiments performed by the current inventors in lab-scale conditions (FIGS. 2, 3, 4, 5) are commonly used trials by to assess the suitability of the material for large scale disk centrifuges and to predict if certain matrixes would reach a good separation.

It is worth noting that in the case of rapeseed seeds the pre-heating of the sample in combination with the pH adjustment (pH 7) may allow the greatest recovery of cream at short times and low g forces. In the case of sunflower seeds, the centrifugation at room temperature favoured the cream recovery. The differences presented by the seeds could be attributed to the differences in size of the oleosomes from each seed origin and to the type of vegetable protein and their modifications triggered at the mentioned temperature.

### Characterizations

Table 3 provides an overview of the biochemical composition of the three obtained fractions, confirming that the highest relative content of lipid, protein and carbohydrate were present in the lipid- protein- and carbohydrate-enriched fractions, respectively. For example, the lipid-enriched fraction obtained from canola seed contained more than 85 wt. % lipid, whereas the lipid content in the protein- and carbohydrate-enriched fractions was less than 35 wt. % and 5 wt. %, respectively. In agreement, the lipid-enriched fraction obtained from sunflower seed contained more than 90 wt. % lipid, whereas the lipid content in the protein- and carbohydrate-enriched fractions was less than 35 wt. % and 3 wt. %, respectively.

The amount of ashes was always below 0.2 wt. % (protein and lipid fractions) and below 8% (carbohydrate fractions), irrespective of the type of seed used. As shown in Table 4, the total phenolic content (TPC) was between 10 and 45 (mg gallic acid equivalence/g product) for all the obtained fractions. The antioxidant capacity was between 40% and 100% (singlet oxygen radical scavenging capacity) for all the obtained fractions. This indicates that all fractions have similar nutritional value with respect to the antioxidant properties. Combined, the data demonstrate that there was a low amount of anti-nutritional factors and high nutritional value of the various enriched fractions obtained by the current method.

The content of the anti-nutrient glucosinolate was very low in all fractions derived from canola (Table 5). In the lipid fraction, all glucosinolates were present in an amount below 0.05 (μmol/g). In the protein fraction, all glucosinolates were present in amount below 1 μmol/g, typically below 0.05 μmol/g. In the carbohydrate fraction, all glucosinolates were present in an amount below 0.1 μmol/g, typically below 0.05 μmol/g.

The anti-nutrient phytic acid was also found to be very low, e.g. below 2%, in all fractions derived from canola, and lowest in the lipid fraction (<0.14%) (Table 5).

TABLE 3
Biochemical composition of the enriched fractions (based on dry weight).Data are expressed
as % of lyophilised fractions.Values are expressed as mean ± standard deviation (n = 3).

| Enriched | Carbohydrates | | Proteins | | Lipids | | Ashes | | Moisture | |
|---|---|---|---|---|---|---|---|---|---|---|
| fraction/ | Centr. | Centr. | Centr. | Centr. | Centr. | Centr. | Centr. | Centr. | Centr. | Centr. |
| type of seed | RT | 50 C. | RT | 50 C. | RT | 50 C. | RT | 50 C. | RT | 50 C. |
| Lipid | 5.42 ± | 6.02 ± | 27.12 ± | 27.60 ± | 86.27 ± | 82.12 ± | 0.21 ± | 0.36 ± | 1.36 ± | 0.92 ± |
| fraction/ | 0.10 | 0.11 | 0.87 | 0.26 | 1.82 | 2.79 | 0.01 | 0.17 | 0.28 | 0.73 |
| canola seed | | | | | | | | | | |
| Protein | 6.60 ± | 15.47 ± | 68.24 ± | 61.74 ± | 34.75 ± | 28.94 ± | 0.18 ± | 0.19 ± | 0.95 ± | 1.26 ± |
| fraction/ | 0.21 | 0.45 | 1.52 | 0.84 | 0.58 | 0.17 | 0.21 | 0.04 | 0.16 | 0.03 |
| canola seed | | | | | | | | | | |
| Carbohydrate | 24.11 ± | 25.73 ± | 36.28 ± | 35.41 ± | 4.13 ± | 2.78 ± | 7.12 ± | 6.86 ± | 5.72 ± | 5.80 ± |
| fraction/ | 2.46 | 3.10 | 0.09 | 1.17 | 2.10 | 0.36 | 0.22 | 0.14 | 0.21 | 0.67 |
| canola seed | TDFs* | TDFs* | | | | | | | | |
| | 28.36 | 29.22 | | | | | | | | |
| Lipid | 2.76 ± | 2.27 ± | 25.78 ± | 24.88 ± | 94.39 ± | 95.41 ± | 0.17 ± | 0.10 ± | 1.11 ± | 1.06 ± |
| fraction/ | 0.64 | 0.54 | 1.01 | 0.34 | 3.96 | 0.91 | 0.65 | 0.24 | 2.04 | 0.58 |
| sunflower | | | | | | | | | | |
| seed | | | | | | | | | | |
| Protein | 11.86 ± | 17.80 ± | 34.69 ± | 38.58 ± | 39.80 ± | 40.12 ± | 0.08 ± | 0.14 ± | 0.44 ± | 0.32 ± |
| fraction/ | 0.62 | 0.66 | 2.26 | 1.14 | 1.22 | 2.39 | 0.21 | 0.23 | 0.02 | 0.27 |
| sunflower | | | | | | | | | | |
| seed | | | | | | | | | | |
| Carbohydrate | 24.11 ± | 24.08 ± | 29.55 ± | 31.24 ± | 0.74 ± | 1.92 ± | 7.81 ± | 6.95 ± | 4.81 ± | 3.91 ± |
| fraction/ | 1.56 | 0.90 | 1.72 | 0.18 | 0.85 | 0.97 | 0.26 | 0.55 | 0.68 | 0.02 |
| sunflower | TDFs* | TDFs* | | | | | | | | |
| seed | 37.79 | 35.81 | | | | | | | | |

Centr., Centrifugation;
RT, room temperature;
TDFs, total dietary fibres
*TDFs are calculated by difference (100 − Carbohydrates − Proteins − Lipids − Ashes)

TABLE 4
Total phenolic content (TPC) and antioxidant capacity (AC)
of canola and sunflower seeds used in the present process
(based on dry weight). Data are expressed as mg gallic acid equivalent
(GAE) g⁻¹ of analysed seeds for TPC and as % singlet
oxygen radical scavenging capacity. Values are expressed
as mean ± standard deviation (n = 3).

| Enriched fraction/ | | |
|---|---|---|
| type of seed | TPC | AC |
| Lipid fraction/ | 41.25 ± 1.90 | 88.9 ± 1.90 |
| canola seed | | |
| Protein fraction/ | 37.51 ± 2.10 | 81.1 ± 3.27 |
| canola seed | | |
| Carbohydrate | 11.63 ± 0.52 | 46.8 ± 2.81 |
| fraction/ | | |
| canola seed | | |
| Lipid fraction/ | 36.73 ± 3.70 | 77.1 ± 8.43 |
| sunflower seed | | |
| Protein fraction/ | 39.56 ± 2.17 | 96.5 ± 1.79 |
| sunflower seed | | |
| Carbohydrate | 28.24 ± 2.82 | 56.3 ± 2.15 |
| fraction/ | | |
| sunflower seed | | |

TABLE 5
Phytic acid content (%) and glucosinolate content (μmol/g)
in the enriched fractions derived from canola seeds.

| | Lipid | Protein | Carbohydrate |
|---|---|---|---|
| | fraction | fraction | fraction |
| Phytic Acid (%) | | | |
| Phytic acid | <0.14 | 1.69 | 1.22 |
| Glucosinolates (μmol/g) | | | |
| Glucoiberin | <0.05 | <0.05 | <0.05 |
| Progoitrin | <0.05 | 0.97 | 0.09 |
| Epiprogoitrin | <0.05 | <0.05 | <0.05 |
| Glucoraphanin | <0.05 | <0.05 | <0.05 |
| Gluconapoleiferin | <0.05 | 0.08 | <0.05 |
| Glucoalyssin | <0.05 | 0.16 | <0.05 |
| Sinalbin | <0.05 | <0.05 | <0.05 |
| Gluconapin | <0.05 | 0.59 | 0.06 |
| 4-Hydroxyglucobrassicin | <0.05 | <0.05 | <0.05 |
| Glucobrassicanapin | <0.05 | 0.15 | <0.05 |
| Glucotropaeolin | <0.05 | <0.05 | <0.05 |
| Glucoerucin | <0.05 | <0.05 | <0.05 |
| Glucobrassicin | <0.05 | <0.05 | <0.05 |
| Gluconasturtiin | <0.05 | <0.05 | <0.05 |
| Neoglucobrassicin | <0.05 | <0.05 | <0.05 |

### CONCLUSION

Using canola and sunflower seeds as example, the results herein prove the effectiveness of the fractionation method presented herein. The biochemical measurements demonstrated successful separation of the three fractions, with a satisfactory nutritional profile and low amount of anti-nutritional factors.

Forming the basis of the invention disclosed herein, the current inventors identified surprisingly large advantages when applying a specific soaking and/or pH adjustment step.

First, the current inventors identified that soaking of plant seeds at reduced time, but at increased temperature improves the fractionation process. Based on the data presented in FIG. 2, the current inventors identified that soaking is preferably performed at 50-70° C. and preferably for 30-150 minutes. With this combination, the highest stability and longest shelf-life may be achieved, furthermore with an improved lipid aggregation in the liquid fraction prior to centrifugation. This soaking condition may render the process scalable at an industrial level, allow lower energy consumption (reduction of g forces), and facilitate the separation of lipids and/or oleosomes. The relatively short soaking time furthermore significantly speeds up the total isolation time and therefore also reduces the chance of microbial growth, among the many other possible advantages.

Second, the current inventors established that a novel pH adjustment step to avoid alkaline conditions prior to liquid-liquid separation induces rapid and improved lipid aggregation in the form of cream condensation. This novel step involves changing the pH of the liquid fraction (typically lowering the pH) to avoid alkaline conditions. Based on the data as presented in FIGS. 3-5, the pH adjustment preferably sets the pH of the liquid fraction to a pH of 4.0-7.5, more preferably a pH of 5.0-6.5. The presented pH adjustment step deviates from the common extraction protocols using entirely alkaline conditions, which are taught to increase the solubility and release of proteins that become negatively charged. The change of pH towards neutral or weak acidic pH strongly enables/facilitates the separation of lipid- and protein-enriched fractions with less centrigution steps and using lower forces. Moreover, this could be translated to the use of large scale centrifugation methods, for example by disk centrifugation. Together, the isolation method presented herein also represents an optimization of resources, foremost less electric energy and water consumption.

### Example 2

Main goal: observe the differences among the three extraction products as obtainable by the present method, in one case while adjusting the pH with acetic acid to 5.5 (adjusted pH) and in one case avoiding the use of acetic acid (not adjusted pH). The components analyzed are: phenolic content, protein content and ashes.

Lipid fraction, protein fraction, and carbohydrate fraction are hereafter named cream or cano-cream, soluble or cano-soluble, fiber or cano-fiber; respectively.

STARTING MATERIAL 0.5 kg of dry canola seeds (250 g for one trial—no adj pH with acetic acid and 250 g for the other trial—adj pH with acetic acid).

### Rinsing Seeds to Remove Dust (Running Water Through Seeds Stocked in a Sieve)

Aim: Removing dust and particles from seeds.

Process: The process starts with washing the whole seeds. Place seeds inside of a sieve with a particle size of 1.5 mm, hold below the tap with running water for 2 minutes and use your hand to aid the cleaning (wash the seeds till the water from the sieve comes out clean).

The sieve is stirred manually with circular and movements in order to make the passage of water between the seeds as homogeneous as possible.

### Drain the Seeds

Aim: Remove the excess water in the seeds.

Process: The seeds are left to drain from the excess water for 5 minutes (or till no water is coming out from the cheesecloth anymore).

### Blanching of the Washed Seeds

Aim: Blanching is useful to reduce enzymatic activity and microbial growth. Then, by reducing the bacterial load at the beginning of the process it is possible to extend the shelf life and the stability of the produced ingredients.

Process: A pot (maximum capacity of 5 L) is put on the fire. 2 L of tap water are added to the pot and with a kitchen thermometer constantly monitors the temperature till it will reach 70 C. As soon as 70 C is reached the whole sieve containing the seeds (from the previous step), is immersed for 1 minute in the pre-heated water. After this step, the sieve containing the seeds is taken out from the pot and left at room temperature for cooling (15 minutes).

### Soaking of the Blanched Seeds

Aim: Soaking will allow hydration of the seeds, useful for the following step of crushing.

Process: The seeds were transferred from the sieve to a pot (maximum capacity 5 L) and then the seeds were mixed with 0.1 M NaHCO₃ (the solution of NaHCO₃ initially prepared with pH 9.5) in a proportion of 1:1, ie. 0.5 kg of dried seeds and 0.5 kg of NaHCO₃. The pot with the mixture is warmed at 60° C. for 60 minutes and (gently) manually stirred constantly. The temperature was monitored with a kitchen thermometer. At the end of the 60 min almost 90% of the NaHCO₃ solution is absorbed by the seeds.

Total weight of rehydrated seeds+residual liquid (after 60 min)=1017 g pH of the residual liquid 7.9.

### Crushing of Seeds Through Twin Screw Press

Aim: Crush the seeds to obtain the cano-extract (liquid stream) and cano-fiber (fibrous residues after crushing).

Process: The pre-soaked seeds are constantly fed into the twin screw press (from Angel Juicer Co., LTD; model Angelia Series 7500) which has attached a filter with a pore size of 0.5 mm. Along the device, the semi-wet fibrous material (cano-fiber) is recovered in a bucket and at the end of the screws a slurry like material denominated concentrated the first extract (cano-slurry) is recovered in a bucket. During the crushing, the temperature was maintained constant at 20° C. (room with air conditioning). This parameter seems to be very important to prevent later oxidation.

Weight of cano-slurry=470 g

Weight of the wet cano-fiber=441 g

pH cano-slurry=7.17.

Removal of Insoluble Fiber from the Twin Screw Press

Aim: Remove after the crushing of seeds at the top of the machine (below the protective cover) sticky ultra fine wet fiber.

Process: The residues were removed from the twin screw opening the cover of the machine and scooping them out. This fine fiber, if added to the cano-slurry can create too many residues at the bottom of the falcon, in the phase of recovery in the lab centrifuge.

Wet residues within the twin screw press=35 g

### Drying of the Wet Fibrous Material

Aim: Dry the wet fibrous material (named cano-fiber).

Process: Dried at 70° C. for 6 h or until constant weight in a ventilated oven.

In case of visible lumps composed of aggregated wet fibers, manually dissolve the lumps before drying.

Weight of dry cano-fiber (after 7 h at 70 C)=295 g

### First Dilution (Alkaline) of the Concentrated First Extract

Aim: Dilute the concentrated first extract to aid the separation of the different cellular components.

Process: All the cano-slurry is re-diluted in a ratio of 1:3 based on the initial weight of the dried seeds, ie for 0.5 kg of initial seeds->1.5 kg of NaHCO₃. The mixture (named cano-extract) is gently manually stirred for 10 min (stir until the mixture looks homogeneous and the pH is constant).

Weight of cano-slurry after first (alkaline) dilution=1.942 g

pH of the cano-slurry after first (alkaline) dilution=9.22

After the dilution the color of the cano-extract significantly changed in a brilliant yellow.

After this step, half cano-extract (971 mL) is placed in a pot and the other half (971 mL) in another pot.

### Second Dilution (Acid) of Cano-Extract

Aim: Dilute the cano-extract with CH₃COOH solution [0.1 M] to aggregate lipids and/or proteins in the liquid fraction.

Process: Only for half of the tot cano-extract amount a dilution with acetic acid is carried out. The cano-extract is diluted 1:1 with acetic acid [0.1 M], ie 971 g of cano-extract and 971 g of acetic acid, the mixture is gently stirred for 2 minutes or until the pH is constant and it reaches 5.5. The solution has to be homogeneous; a change in color from brilliant yellow, before the dilution to whitish occurred.

The solution was allowed to stabilize for a further 10 min or until the pH is constant at 5.5. Final volume cano-extract after second (acid) dilution=1828 g

pH of the cano-extract after second (acid) dilution=5.93 after 5 min—stable even after 1 h. It has been added 2 mL acetic acid (pure) to reach 5.5

pH of the cano-extract not diluted=9.25

### Centrifugation of the Liquid (Separation of Cream, Soluble and Residues)

Aim: Recovery of cream from cano-extract.

Process: The cano-extract (pH adj and pH not adj) is centrifuged with param. 3600 g×10 min at room temperature.

For cano-extract pH adj, a liquid phase (cano-soluble with pH 5.51) and a fat phase (cano-cream with pH 5.54) is obtained.

For cano-extract pH not adj, a liquid phase (cano-soluble with pH 9.26) and a fat phase (cano-cream with pH 9.33) is obtained.

Very evident that after centrifugation, cano-cream in not adj pH sample is very few, just a thin layer not consistent at the top of the falcon. Even the residues are differently distributed (compared to adj pH sample) at the bottom of the falcon (much more cano-cream in the sample not adj pH in entrapped in the residues at the bottom).

Weight of cano-cream pH adj=78 g

Weight of cano-cream pH not adj=19 g

Weight of cano-soluble pH adj=1.535 g

Weight of cano-soluble pH not adj=803 g

Weight of cano-residues wet pH adj (pellet at the bottom part of the falcon)=98 g

Weight of cano-residues wet pH not adj (pellet at the bottom part of the falcon)=135 g

More residues at the bottom of the falcon for samples not adj pH, as we can see by the quantification reported above.

Thin Layer of the Sample not Adj pH after Centrifugation

Although it appears that, in the not adj pH sample, there is a comparable amount of cream (compared to the adj pH sample) at the top of the falcon, in reality, this is not the case. In the sample not adj pH there is only a thin layer of cream at the top of the falcon, inconsistent and very bright yellow.

Resides at the Bottom of the Falcon of the Samples after Centrifugation

Much more cream is entrapped in residues at the bottom of the falcon for the sample not adj pH.

After 5 days, the soluble sample adj pH was stable in terms of color; while, the not adj one turned to green, which indicates oxidation.

### Main Differences Between Cano-Cream and Cano-Soluble

| Sample | Color | Consistency | Taste |
|---|---|---|---|
| Cano-cream | Whitish (e.g. anti- | Mayonnaise-like | Slightly |
| adj pH | oxidant activity | texture | mustard |
| | of >75% singlet oxygen | (semi-solid) | flavor |
| | radical scavenging | | |
| | capacity) | | |
| Cano-cream | Light Yellow (e.g. | Very liquid | Accentuated |
| not adj pH | anti-oxidant activity | | mustard/ |
| | of <75% singlet oxygen | | spicy flavor |
| | radical scavenging | | |
| | capacity) | | |
| Cano-soluble | Yellow (e.g. anti- | Liquid | Almost |
| adj pH | oxidant activity | | neutral |
| | of >80% singlet oxygen | | |
| | radical scavenging | | |
| | capacity) | | |
| Cano-soluble | Brilliant yellow (e.g. | Liquid | Slightly |
| not adj pH | anti-oxidant activity | | bitter |
| | of <80% singlet oxygen | | |
| | radical scavenging | | |
| | capacity) | | |

For phenolic determination and protein determination (reported below), dilutions for cream and soluble were adopted in order to make the dry solids comparable among samples.

### Results on Phenolics Quantification

Procedure: 200 uL of each sample were taken (cano-cream adj and not adj pH and cano-soluble adj and not adj pH) and placed inside plastic cuvettes.

An aqueous extract for the cano-fiber sample was prepared. 5 g of wet cano-fiber were mixed with 10 mL of dd water preheated to 80° C. The mixture was then centrifuged at 4000 rpm for 10 min. The supernatant was recovered and 200 μL of this solution were placed into the cuvettes. A positive control (green te, LongLife brand) was used. One capsule, containing 0.55 g of powder equivalent to 367 mg of polyphonols, was solubilized in 5 mL of dd water and stored at 4° C. in the dark until its use. 200 μL of this solution was used as a control sample. The negative control is represented by dd water.

Then, 50 mL of 2% Na₂CO₃ solution were prepared. The solution of Folin-Ciocalteu reagent was removed from the fridge to allow it to reach room temperature.

2 mL of the Na₂CO₃ sol were added in each cuvette and mixed. After 3 min 100 μL of the Folin-Ciocalteu reagent were added (activating the colorimetric reaction, able to indicate the presence of phenols). The mixture was let to react in the dark at 25 C for 30 min. The absorbance was measured at 720 nm using a UV-Vis spectrophotometric reader.

Total phenolics
(mg gallic acid equivalent GAE/g wet sample analysed)

Cano-cream adj pH
4.13 ± 0.19 a (e.g. between 30-50 mg GAE/g dry sample)
Cano-cream not adj pH
8.64 ± 2.30 b (e.g. above 50 mg GAE/g dry sample)
Cano-soluble adj pH
7.51 ± 0.68 b (e.g. between 30-50 mg GAE/g dry sample)
Cano-soluble not adj pH
4.72 ± 0.64 a (e.g. below 30 mg GAE/g dry sample)

Different letters in a row for the same group denote a significant difference (P<0.05). Statistical differences were determined using ANOVA followed by the Duncan's Multiple Range Tests (MRT) to determine the Least Significant Difference (LSD). Differences were considered significant when P<0.05.

### Results on Protein

Procedure: Lowry, O. H.; Rosebrough, N.J.; Farr, L.; Randall, R. J. Protein measurement with the Folin phenol reagent. J. Biol. Chem. 1951, 193, 265-275.

Protein (%)

Cano-cream adj pH
0.22 ± 0.08 a (e.g. 15 wt. % to 30 wt. % protein with respect to
dry sample)
Cano-cream not adj pH
0.48 ± 0.03 b (e.g. >30 wt. % protein with respect to dry sample)
Cano-soluble adj pH
0.51 ± 0.03 b (e.g. >50 wt. % protein with respect to dry sample)
Cano-soluble not adj pH
0.24 ± 0.03 a (e.g. <50 wt. % protein with respect to dry sample)

Different letters in a row for the same group denote a significant difference (P<0.05). Statistical differences were determined using ANOVA followed by the Duncan's Multiple Range Tests (MRT) to determine the Least Significant Difference (LSD). Differences were considered significant when P<0.05.

1. Method for obtaining a lipid-containing composition, a protein-containing composition and a carbohydrate-containing composition, the method comprising:
a) providing plant seeds;
b) immersing the plant seeds provided in step a) in an aqueous medium to obtain plant seeds comprising aqueous medium;
c) comminuting the plant seeds comprising aqueous medium obtained in step b) to obtain a liquid fraction and a solid fraction, wherein the liquid fraction comprises lipid and protein, in a lipid:protein ratio of between 10:1 (w/w) and 1:10 (w/w), and wherein the solid fraction is the carbohydrate-containing composition;
d) adjusting the pH of the liquid fraction obtained in step c) to a pH of between 4.0-6.5, to aggregate lipids in the liquid fraction; and
e) separating the aggregated lipids from the liquid fraction obtained in step d) to obtain the lipid-containing composition and the protein-containing composition.

2. Method according to claim 1, wherein the aqueous medium in step b) has a temperature of between 50-70° C. and/or wherein the immersing in step b) is performed for a time period of between 30 and 150 minutes.

3. Method according to claim 1, wherein step b) is preceded by immersing the plant seeds in an aqueous medium having a temperature of between 60-80° C.

4. Method according to claim 1, wherein the comminuting in step c) is performed by any one or more of blending, pressing, screw pressing, twin screw pressing, mixing, homogenising, extruding, grinding.

5. Method according to claim 1, wherein step c) comprises, before said comminuting, immersing the plant seeds comprising aqueous medium in aqueous medium in a plant seeds:aqueous medium ratio of 1:1-1:12, based on the weight of the plant seeds comprising aqueous medium.

6. Method according to claim 1, wherein step c) additionally comprises filtering the comminuted plant seeds comprising aqueous medium to separate a liquid fraction and a solid fraction.

7. Method according to claim 1, wherein step d) is performed by adding or combining with an acid and/or acidic medium.

8. Method according to claim 1, wherein the liquid fraction is heated to 30-70° C. after adjusting the pH in step d).

9. Method according to claim 1, wherein step e) is performed by centrifugation, wherein the centrifugation comprises continuous density gradient centrifugation.

10. Method according to claim 1, wherein said aqueous medium of step b):
is a sodium bicarbonate (NaHCO₃) solution; and/or
has pH of between 8 and 11.

11. Method according to claim 1, wherein the plant seeds are oil-rich plant seeds chosen from sunflower seeds, rapeseeds, pumpkin seeds, cotton seeds, maize seeds, canola seeds, safflower seeds, sesame seeds, or combinations thereof.

12. Method according to claim 1, wherein steps a) to e) together are performed in a total time of in between 1 minute and 8 hours and/or are performed in a continuous process.

13. Product containing at least 50 wt. % protein, 5 wt. % to 20 wt. % carbohydrate, 25 wt. % to 45 wt. % lipid, and less than 1 wt. % ashes, and furthermore having:
less than 0.05 wt. % erucic acid;
less than 5 wt. %. glucosinolate;
a total phenolic content of 30 to 50, expressed as mg gallic acid equivalent (GAE)/g of product; and/or
an antioxidant capacity of 80 to 100, expressed as % singlet oxygen radical scavenging capacity.

14. Product containing at least 65 wt. % lipid, 15 wt. % to 30 wt. % protein, 1 wt. % to 5 wt. % carbohydrate, and less than 1 wt. % ashes, and furthermore having:
less than 0.05 wt. % erucic acid;
less than 5 wt. %. glucosinolate;
a total phenolic content of 30 to 50, expressed as mg gallic acid equivalent (GAE)/g of product; and/or
an antioxidant capacity of 75 to 95, expressed as % singlet oxygen radical scavenging capacity.

15. Product containing at least 50 wt. % carbohydrate, 25 wt. % to 40 wt. % protein, 0.5 wt. % to 5 wt. % lipid, and less than 5 wt. % ashes, and furthermore having:
less than 0.05 wt. % erucic acid;
less than 5 wt. %. glucosinolate;
a total phenolic content of 20 to 40, expressed as mg gallic acid equivalent (GAE)/g of product; and/or
an antioxidant capacity of 60 to 80, expressed as % singlet oxygen radical scavenging capacity.

16. The method according to claim 10, wherein the NaHCO₃ solution has a molarity of 0.05 and 0.5M and a pH of between 8.5 and 9.5.

17. The method according to claim 7, wherein the acid and/or acidic medium comprises at least one of HCl, CH₃COOH, or C₆H₈O₇.

18. The product of claim 13, wherein the product contains at least 70 wt. % protein, less than 0.2 wt. % ashes, less than 0.005 wt. % erucic acid, and less than 2 wt. % glucosinolate.

19. The product of claim 14, wherein the product contains at least 85 wt. % lipid, less than 0.2 wt. % ashes, less than 0.005 wt. % erucic acid, and less than 2 wt. % glucosinolate.

20. The product of claim 15, wherein the product contains at least 60 wt. % carbohydrate, less than 2 wt. % ashes, less than 0.005 wt. % erucic acid, and less than 0.5 wt. % glucosinolate.
